(19) United States
(12) Patent Application Publication
(10) Pub. No.: US 2026/0249324 A1
(43) Pub. Date: Aug. 27, 2026

(54) OSCILLATORY ACTUATOR AND ELECTRIC DEVICE

(71) Applicants: Katsuhiro HASHIMOTO, Tokyo (JP); Yosuke KINOSHITA, Tokyo (JP); Yoshihiro MAEDA, Tokyo (JP)

(72) Inventors: Katsuhiro HASHIMOTO, Tokyo (JP); Yosuke KINOSHITA, Tokyo (JP); Yoshihiro MAEDA, Tokyo (JP)

(73) Assignee: MINEBEA MITSUMI Inc., Nagano (JP)

(21) Appl. No.: 19/155,959

(22) PCT Filed: Feb. 9, 2024
(86) PCT No.: PCT/JP2024/004477

§ 371 Date: Aug. 13, 2025

(30) Foreign Application Priority Data
Feb. 17, 2023 (JP) 2023-023768

(51) Int. Cl. B06B 1/04

(52) U.S. Cl. CPC B06B 1/045

(57) ABSTRACT

Provided is an oscillatory actuator that linearly oscillates using resonance, wherein the frequency bandwidth at which a desired oscillation strength can be output is broadened. The oscillatory actuator has a magnetic spring that generates magnetic force that biases an oscillating movable body toward the center position of oscillation. The magnetic spring is configured such that the magnetic force that occurs when the movable body has a large displacement from the center position is smaller than the magnetic force that occurs when the movable body has a small displacement from the center position.

### TECHNICAL FIELD

The present invention relates to a vibration actuator and an electric device including the same.

### BACKGROUND ART

An actuator (vibration actuator) as a vibration generation source is generally mounted on an electric device having a vibration function. By driving the vibration actuator and transmitting vibration to a user so that they can physically perceive them, the electric device can apply a stimulus, notify of an incoming call, or improve an operation feeling or presence. The electric device includes portable game terminals, controllers (gamepads and the like) of stationary game machines, mobile communication terminals such as mobile phones and smartphones, portable information terminals such as tablet personal computers (PC), and the like, as well as various health care devices and beauty devices that provide massage and the like to the user.

An example of a vibration actuator in the related art includes a coil disposed inside a tubular case, a movable element having a permanent magnet, and an elastic support member that supports the movable element such that the movable element is capable of vibrating in an axial direction inside the coil (see, for example, Patent Literature (hereinafter, referred to as “PTL”) 1). In such a vibration actuator, in a case where a current having a predetermined frequency is applied to the coil, the movable element reciprocates, that is, vibrates by a driving force of a voice coil motor composed of the coil and the permanent magnet, and the vibration is output from the vibration actuator to the outside.

### CITATION LIST

### Patent Literature

### PTL 1

Japanese Patent Application Laid-Open No. 2020-054018

### SUMMARY OF INVENTION

### Technical Problem

In the above-described vibration actuator, the movable element and the elastic support member are in a relationship of constituting a spring-mass vibration model. That is, in a case where an alternating current (AC) wave having a frequency equal to a resonance frequency of the spring-mass system is input to the coil, the movable element enters a resonance state, and high-output vibration can be obtained from the vibration actuator. In other words, in a case where the resonance is utilized, the driving efficiency of the vibration actuator is improved. Therefore, in a drive control section that drives the vibration actuator using the resonance, a driving frequency is preset to a value equal to or close to the resonance frequency.

However, in a typical spring-mass system vibration model, a G value (also referred to as an impact value or a vibration intensity) becomes high only in a case where an alternating current (AC) frequency in the vicinity of the resonance frequency is input, and in a case where an input frequency deviates from a value equal to or close to the resonance frequency, the G value becomes extremely low. That is, a frequency bandwidth in which the desired vibration intensity can be output is narrow.

Here, since the coil and the permanent magnet constituting the voice coil motor, which is a driving source of the movable element, have properties in which characteristics change depending on an environmental temperature, the resonance frequency is affected. In addition, particularly, in a case of a structure of only a magnetic spring without a mechanical spring, the influence on the resonance frequency is more significant. Therefore, the resonance frequency may change according to the environmental temperature of the vibration actuator.

Furthermore, the vibration actuator has individual differences due to manufacturing tolerances or assembly tolerances of components, and the resonance frequency may change depending on the individual differences. In a case where the resonance frequency changes and a mismatch occurs or increases between the driving frequency and the resonance frequency, the G value becomes extremely low as described above.

Therefore, there is a demand for a vibration actuator capable of easily maintaining the output of the desired vibration intensity even in a case where the mismatch occurs or increases between the driving frequency and the resonance frequency due to the change in the resonance frequency. More specifically, there is a demand for widening the frequency bandwidth in which the output of the desired vibration intensity is possible.

It should be noted that, instead of widening the frequency bandwidth, it is considered that a dedicated circuit for detecting the resonance frequency and variably setting the driving frequency in accordance with the detected resonance frequency is added to the vibration actuator or the drive control section thereof as a method of increasing the driving efficiency. However, in a case where such a dedicated circuit is provided, there is a concern that the configuration or control becomes complicated in the vibration actuator or the electric device including the vibration actuator, resulting in hindrance of the miniaturization, increase in manufacturing cost, or increase in power consumption.

An object of the present invention is to widen a frequency bandwidth in which a desired vibration intensity can be output in a vibration actuator that linearly vibrates by utilizing resonance.

### Solution to Problem

One aspect of a vibration actuator according to the present invention includes:
a movable body that includes a movable magnet;
a fixed body that includes a pair of coils disposed side by side in an axial direction such that each of the pair of coils surrounds an outer circumference of the movable body, the pair of coils constituting, together with the movable magnet, a motor that causes the movable body to vibrate in the axial direction when the pair of coils are energized; and
a magnetic spring that includes the movable magnet and a magnetic member provided in the fixed body, and generates a magnetic force for biasing the vibrating movable body toward a center position of the vibration, in which
the magnetic spring is configured such that a magnetic force generated in a case where a displacement of the movable body from the center position is large is smaller than a magnetic force generated in a case where the displacement of the movable body from the center position is small.

One aspect of an electric device according to the present invention is handheld or wearable and includes the above-described vibration actuator.

### Advantageous Effects of Invention

According to the present invention, it is possible to widen a frequency bandwidth in which a desired vibration intensity can be output in a vibration actuator that linearly vibrates by utilizing resonance.

### BRIEF DESCRIPTION OF DRAWINGS

FIG. 1 is an external perspective view of a vibration actuator according to Embodiment 1;

FIG. 2A is a side sectional view of the vibration actuator according to Embodiment 1;

FIG. 2B is a perspective sectional view of the vibration actuator according to Embodiment 1;

FIG. 3A is a perspective view of a movable body on which a leaf spring is mounted in the vibration actuator according to Embodiment 1;

FIG. 3B is a perspective sectional view of the movable body shown in FIG. 3A;

FIG. 4A is a perspective sectional view of a fixed body of the vibration actuator according to Embodiment 1;

FIG. 4B is a perspective sectional view of a fixed yoke in the vibration actuator according to Embodiment 1;

FIG. 4C is a side sectional view showing a dimensional relationship between the fixed yoke and a movable-body main body of the movable body in the vibration actuator according to Embodiment 1;

FIG. 4D is a side sectional view showing a dimensional relationship between the fixed yoke and a movable range of the movable body in the vibration actuator according to Embodiment 1;

FIG. 5A is a diagram showing a vibration operation of the vibration actuator according to Embodiment 1, and is a diagram showing a situation in which a thrust force for upward movement acts on the movable body;

FIG. 5B is a diagram showing the vibration operation of the vibration actuator according to Embodiment 1, and is a diagram showing a situation in which a thrust force for downward movement acts on the movable body;

FIG. 6A is a diagram showing a relationship between an increase in amplitude and a decrease in spring constant in the vibration actuator according to Embodiment 1, and is a diagram showing a state in which the movable body is at a vibration center position;

FIG. 6B is a diagram showing the relationship between the increase in amplitude and the decrease in spring constant in the vibration actuator according to Embodiment 1, and is a diagram showing a state in which the movable body is displaced upward from the position shown in FIG. 6A;

FIG. 6C is a diagram showing the relationship between the increase in amplitude and the decrease in spring constant in the vibration actuator according to Embodiment 1, and is a diagram showing a state in which the movable body is further displaced upward from the position shown in FIG. 6B;

FIG. 7 is a diagram showing a widened frequency bandwidth of the vibration actuator according to Embodiment 1;

FIG. 8 is a diagram showing an example of an electric device in which the vibration actuator according to Embodiment 1 is mounted;

FIG. 9 is a diagram showing another example of the electric device in which the vibration actuator according to Embodiment 1 is mounted;

FIG. 10A is a perspective sectional view of a fixed body of a vibration actuator according to Embodiment 2;

FIG. 10B is a perspective sectional view of a fixed yoke in the vibration actuator according to Embodiment 2;

FIG. 10C is a side sectional view showing a dimensional relationship between the fixed yoke and a movable-body main body of a movable body in the vibration actuator according to Embodiment 2;

FIG. 10D is a side sectional view showing a dimensional relationship between the fixed yoke and a movable range of the movable body in the vibration actuator according to Embodiment 2;

FIG. 11A is a perspective sectional view of a fixed body of a vibration actuator according to Embodiment 3;

FIG. 11B is a perspective sectional view of the fixed yoke in the vibration actuator according to Embodiment 3;

FIG. 12A is a perspective sectional view of a fixed body of a vibration actuator according to Embodiment 4;

FIG. 12B is a perspective sectional view of the fixed yoke in the vibration actuator according to Embodiment 4;

FIG. 13A is a perspective sectional view of a fixed body of a vibration actuator according to Embodiment 5;

FIG. 13B is a perspective sectional view of the fixed yoke in the vibration actuator according to Embodiment 5;

FIG. 14A is a side sectional view of a vibration actuator according to Embodiment 6;

FIG. 14B is a perspective sectional view of the vibration actuator according to Embodiment 6;

FIG. 15A is a perspective view of a movable body on which a leaf spring is mounted in the vibration actuator according to Embodiment 6;

FIG. 15B is a perspective sectional view of the movable body shown in FIG. 15A;

FIG. 16 is a perspective sectional view of a fixed body of the vibration actuator according to Embodiment 6;

FIG. 17A is a diagram showing the relationship between the increase in amplitude and the decrease in spring constant in the vibration actuator according to Embodiment 6, and is a diagram showing a state in which the movable body is at a vibration center position;

FIG. 17B is a diagram showing the relationship between the increase in amplitude and the decrease in spring constant in the vibration actuator according to Embodiment 6, and is a diagram showing a state in which the movable body is displaced upward from the position shown in FIG. 17A;

FIG. 17C is a diagram showing the relationship between the increase in amplitude and the decrease in spring constant in the vibration actuator according to Embodiment 6, and is a diagram showing a state in which the movable body is further displaced upward from the position shown in FIG. 17B;

FIG. 18A is a side sectional view of a vibration actuator according to Embodiment 7;

FIG. 18B is a perspective sectional view of the vibration actuator according to Embodiment 7;

FIG. 19A is a perspective view of a movable body on which a leaf spring is mounted in the vibration actuator according to Embodiment 7;

FIG. 19B is a perspective sectional view of the movable body shown in FIG. 19A.

FIG. 20 is a perspective sectional view of a fixed body of the vibration actuator according to Embodiment 7;

FIG. 21A is a side sectional view of a vibration actuator according to Embodiment 8;

FIG. 21B is a perspective sectional view of the vibration actuator according to Embodiment 8;

FIG. 22A is a perspective view of a movable body on which a leaf spring is mounted in the vibration actuator according to Embodiment 8;

FIG. 22B is a perspective sectional view of the movable body shown in FIG. 22A;

FIG. 23 is a perspective sectional view of a fixed body of the vibration actuator according to Embodiment 8;

FIG. 24A is a side sectional view of a vibration actuator according to Embodiment 9;

FIG. 24B is a perspective sectional view of the vibration actuator according to Embodiment 9;

FIG. 25 is a perspective sectional view of a fixed body of the vibration actuator according to Embodiment 9;

FIG. 26A is a side sectional view of a vibration actuator according to Embodiment 10;

FIG. 26B is a perspective sectional view of the vibration actuator according to Embodiment 10;

FIG. 27 is a perspective sectional view of a fixed body of the vibration actuator according to Embodiment 10;

FIG. 28A is a side sectional view of a vibration actuator according to Embodiment 11;

FIG. 28B is a perspective sectional view of the vibration actuator according to Embodiment 11;

FIG. 29A is a perspective view of a movable body on which a leaf spring is mounted in the vibration actuator according to Embodiment 11;

FIG. 29B is a perspective sectional view of the movable body shown in FIG. 29A; and

FIG. 30 is a perspective sectional view of a fixed body of the vibration actuator according to Embodiment 11.

### DESCRIPTION OF EMBODIMENTS

Hereinafter, an embodiment of the present invention will be described in detail with reference to the drawings.

### Embodiment 1

### [Configuration of Vibration Actuator]

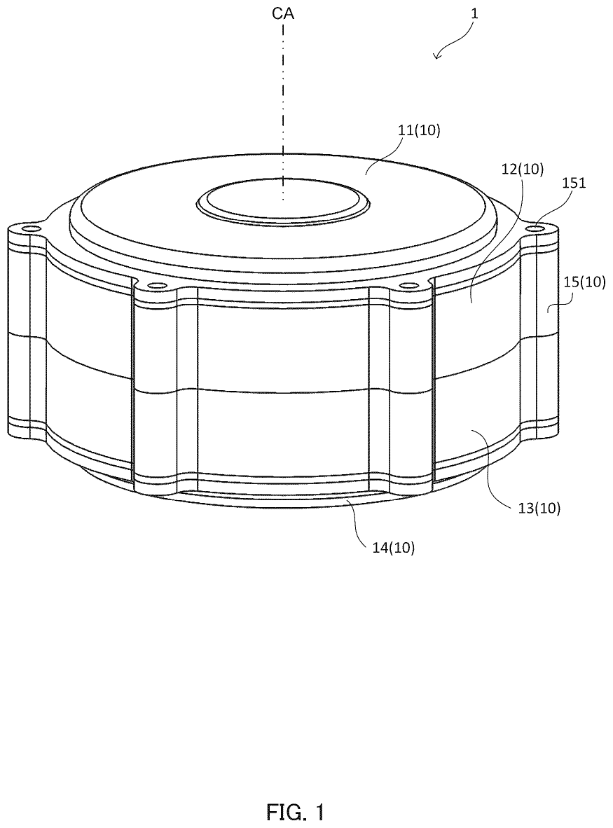

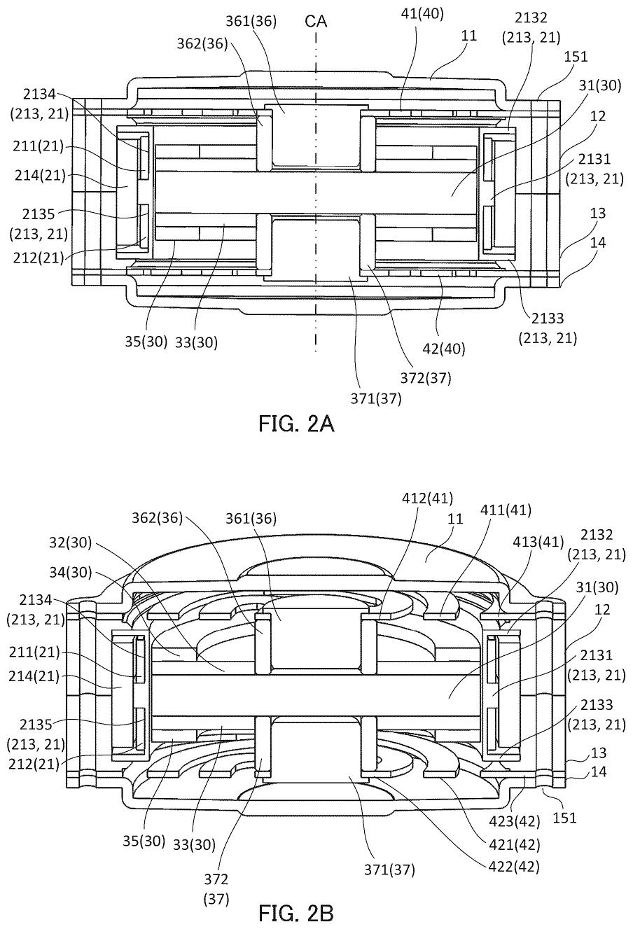

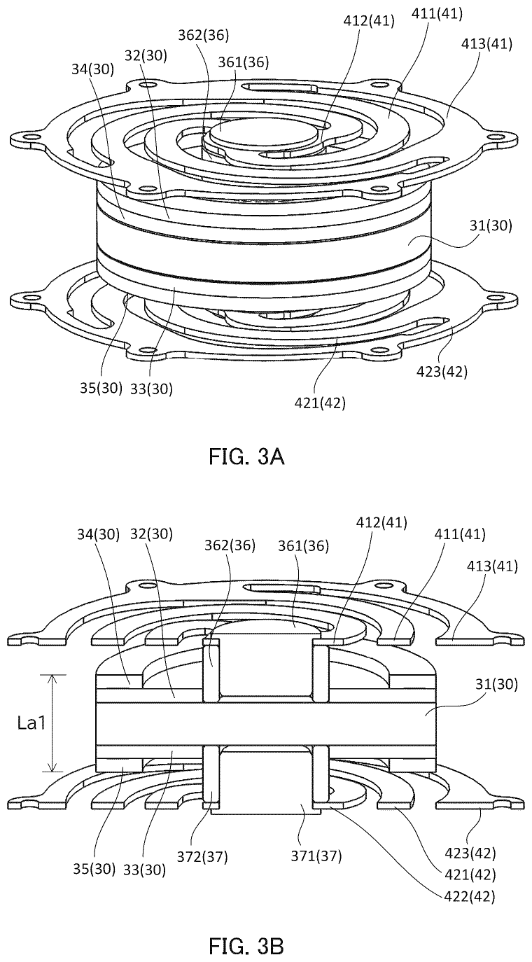

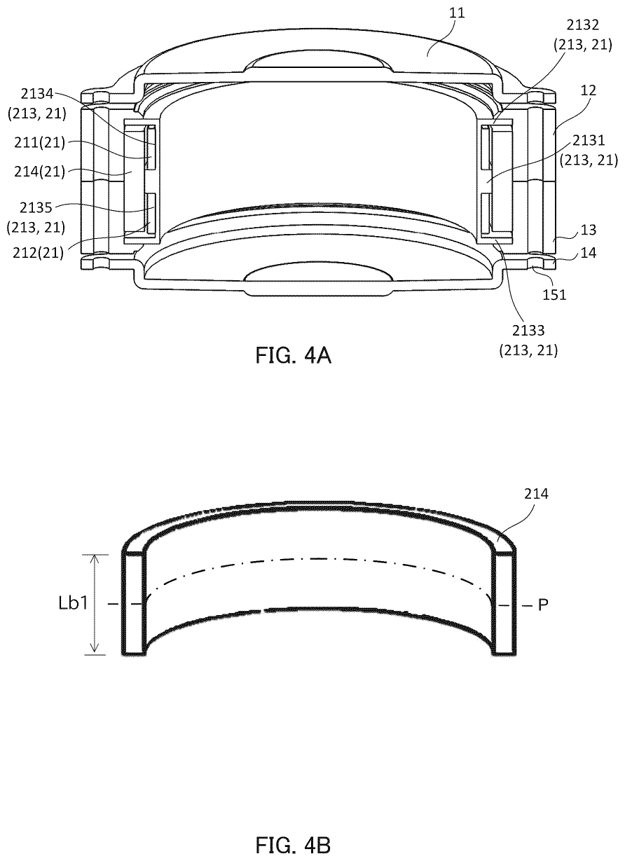

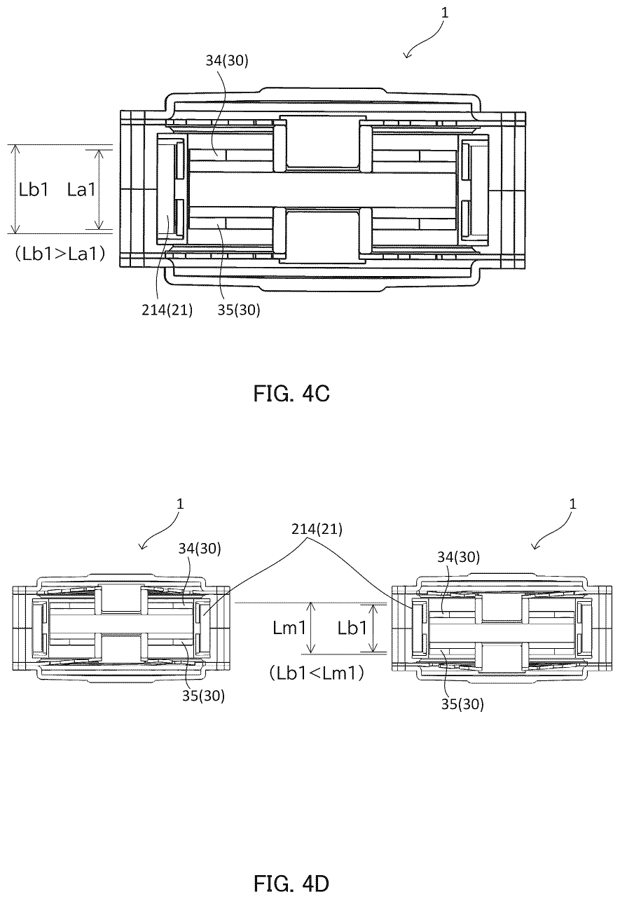

FIG. 1 is an external perspective view of a vibration actuator according to Embodiment 1 of the present invention as viewed from a front side, FIG. 2A is a side sectional view of the vibration actuator according to the present embodiment, FIG. 2B is a perspective sectional view of the vibration actuator according to the present embodiment, FIG. 3A is a perspective view of a movable body on which a leaf spring is mounted in the vibration actuator according to the present embodiment, FIG. 3B is a perspective sectional view of the movable body shown in FIG. 3A, FIG. 4A is a perspective sectional view of a fixed body of the vibration actuator according to the present embodiment, and FIG. 4B is a perspective sectional view of a fixed yoke in the vibration actuator according to the present embodiment.

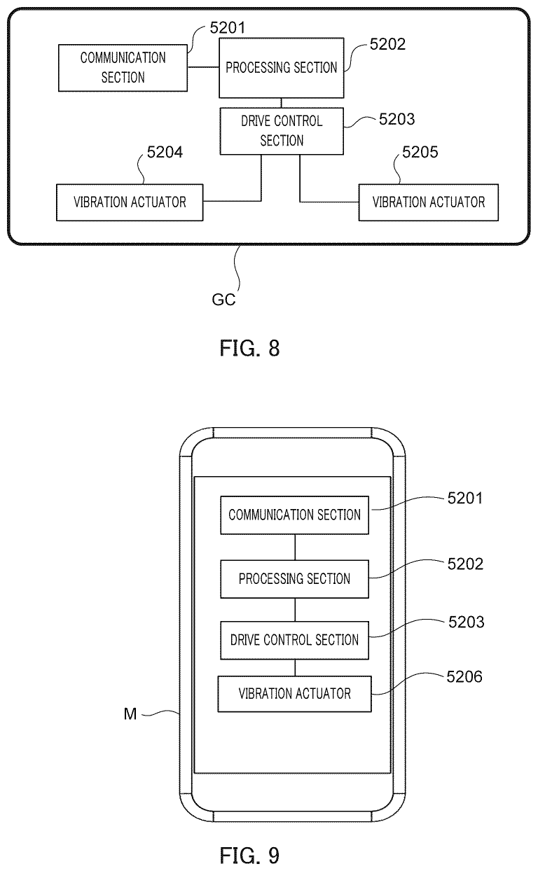

In the following description, the terms “up” and “down” in the terms “upper side” and “lower side” are added for convenience in order to facilitate understanding of the configuration and the behavior of vibration actuator 1 according to the present embodiment. In a case where vibration actuator 1 is mounted on an electric device (see FIGS. 8 and 9), the terms “up” and “down” described herein may be reversed, may be left and right, or may be oblique. Incidentally, in the present embodiment, an up-down direction is a vibration direction of the movable body in vibration actuator 1, the “upward direction” is one of the vibration directions, and the “downward direction” is the other of the vibration directions. That is, vibration actuator 1 is a linear actuator that causes movable body 30 to vibrate linearly in the up-down direction.

In addition, in the following description, unless otherwise specified, the term “radial direction” means a direction extending radially or centrifugally about central axis CA extending in the up-down direction in vibration actuator 1, and the terms “out-” and “in-” in the terms such as “outside” and “inside” mean an outer side and an inner side in the radial direction about central axis CA. In addition, unless otherwise specified, the term “circumferential direction” means a direction extending around central axis CA.

In addition, it goes without saying that expressions related to shapes used in the following description are expressions for convenience in describing the general outline in a simplified manner, and need not necessarily be geometrically accurate definitions of figures. The shape of the entire device or each component described herein is merely an example, and the present invention is not limited to the shape exemplified in the present embodiment.

Vibration actuator 1 is mounted as a vibration generation source on an electronic device such as a portable game terminal device (for example, game controller GC shown in FIG. 8) as an electric device, and realizes a vibration function of the electronic device. Examples of this electronic device also include a portable device (for example, mobile terminal M shown in FIG. 9) such as a smartphone. In addition, examples of the electric device on which vibration actuator 1 can be mounted also include a health care device, a beauty device, and the like that provide massage or the like to the user. Vibration actuator 1 is mounted on various electric devices and vibrates itself due to the vibration of movable body 30 inside vibration actuator 1 to notify the user of an incoming call, to give an operation feeling or presence, or to give a physical stimulus.

### <Fixed Body>

Vibration actuator 1 includes case 10. Case 10 includes upper lid portion 11, upper circumferential wall portion 12, lower circumferential wall portion 13, and lower lid portion 14. Upper lid portion 11 and lower lid portion 14 have a substantially disk-like shape, and upper circumferential wall portion 12 and lower circumferential wall portion 13 have a substantially cylindrical shape. In the present embodiment, each of upper lid portion 11, upper circumferential wall portion 12, lower circumferential wall portion 13, and lower lid portion 14 constituting case 10 is formed of a non-magnetic and non-conductive resin material. Upper lid portion 11, upper circumferential wall portion 12, lower circumferential wall portion 13, and lower lid portion 14 are not limited to being non-magnetic and non-conductive, and may be formed of a magnetic and conductive material, or may be formed of, for example, brass (bronze). Case 10 has stiffness that can reliably transmit the vibration of movable body 30 inside case 10 to a mounting apparatus of vibration actuator 1 through case 10 without absorbing the vibration.

Each of upper lid portion 11, upper circumferential wall portion 12, lower circumferential wall portion 13, and lower lid portion 14 includes coupling portions 15 provided to radially protrude from an outer circumference. Upper lid portion 11, upper circumferential wall portion 12, lower circumferential wall portion 13, and lower lid portion 14 are connected to each other by, for example, fastening fastening members or the like into fastening holes 151 in a state of being stacked concentrically to align circumferential positions of coupling portions 15, thereby forming integrated case 10. An accommodation space for movable body 30 or the like is formed inside fixed body 20 configured to include case 10. Each of coupling portions 15 radially protrudes, and a diameter of a portion other than coupling portion 15 on the outer circumference of case 10 is reduced, so that both the provision of the accommodation space and the reduction in size of case 10 are achieved. In the present embodiment, the number of components of case 10 is four (upper lid portion 11, upper circumferential wall portion 12, lower circumferential wall portion 13, and lower lid portion 14), but the configuration of case 10 can be modified in various ways, and the number of components is not limited to four.

Case 10 forms fixed body 20 in vibration actuator 1. Fixed body 20 includes drive coil assembly 21 in addition to case 10 described above. Movable body 30 and leaf spring part 40 are accommodated inside fixed body 20.

### <Drive Coil Assembly>

Drive coil assembly 21 includes upper drive coil 211, lower drive coil 212, bobbin 213, and fixed yoke 214.

Upper drive coil 211 and lower drive coil 212 are concentrically disposed about central axis CA, and held by bobbin 213 in a state of being disposed side by side along the direction of central axis CA (corresponding to an “axial direction,” and in the present embodiment, the same as the up-down direction). Bobbin 213 is formed of a non-magnetic and non-conductive resin material. An inner circumferential surface of bobbin 213 functions as a protective wall that covers inner circumferential surfaces of upper drive coil 211 and lower drive coil 212 and protects upper drive coil 211 and lower drive coil 212 from direct contact or collision with movable body 30.

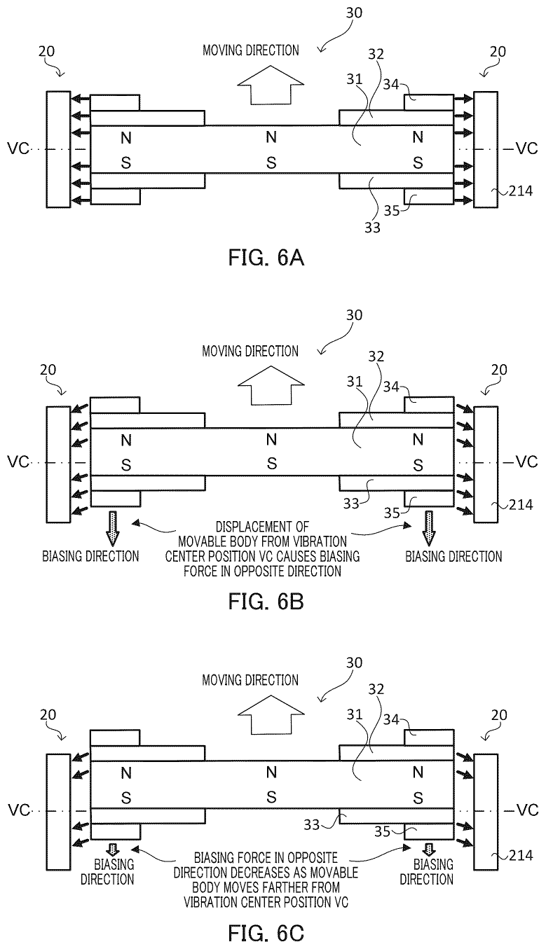

Preferably, upper drive coil 211 and lower drive coil 212 have the same diameter as each other, have the same length in the up-down direction as each other, and are disposed at positions symmetrical to each other in the up-down direction with respect to an intermediate position of the movable range determined by maximum amplitudes of movable body 30 in the up-down direction (which is also vibration center position VC (see FIG. 6A and the like) in the up-down direction). Winding directions of the windings constituting upper drive coil 211 and lower drive coil 212 are opposite to each other.

Two grooves 2134 and 2135, which are defined by intermediate flange 2131 and end portion flanges 2132 and 2133 extending outward from the intermediate portion (a position corresponding to vibration center position VC in bobbin 213) and both end portions in the up-down direction, are provided in an outer circumferential surface of bobbin 213, and upper drive coil 211 and lower drive coil 212 are disposed in upper groove 2134 and lower groove 2135, respectively.

The windings constituting upper drive coil 211 and lower drive coil 212 may be formed of a single wire. In this configuration, a wire intermediate portion corresponding to a portion where upper drive coil 211 and lower drive coil 212 are connected to each other is disposed across intermediate flange 2131. In addition, since it is necessary to enable the energization of upper drive coil 211 and lower drive coil 212, both end portions of the wire corresponding to portions opposite to the portions where upper drive coil 211 and lower drive coil 212 are connected to each other are electrically connected to an external drive circuit (for example, drive control section 5203 in FIGS. 8 and 9). The both end portions of the wire of each of upper drive coil 211 and lower drive coil 212 are brought out to the outside via an opening portion (not shown) provided in case 10, for example, by bypassing both upper and lower end portions of fixed yoke 214. A connection terminal for connection to the outside may be provided in fixed body 20, and the both end portions of the wire may be connected to the connection terminal.

Fixed yoke 214 is disposed to surround the outer circumferences of upper drive coil 211 and lower drive coil 212. Fixed yoke 214 is a member made of a non-magnetized magnetic material and having a tubular shape as a whole. Fixed yoke 214 is disposed between end portion flanges 2132 and 2133 of bobbin 213. In addition, fixed yoke 214 is disposed to extend in both the upward and downward directions from intermediate portion P corresponding to a center position (vibration center position VC) of the movable range of movable body 30. Preferably, in fixed yoke 214, an upper half portion extending upward from intermediate portion P and a lower half portion extending downward from intermediate portion P have the same length. In addition, preferably, an inner circumferential surface and the outer circumferential surface of fixed yoke 214 are flat surfaces without unevenness or inclination, and an inner diameter of fixed yoke 214 is the same over an entire length in the up-down direction.

Drive coil assembly 21 is held on an inner circumferential surface of a circumferential wall portion constituted by upper circumferential wall portion 12 and lower circumferential wall portion 13. In the present embodiment, drive coil assembly 21 is interposed between upper circumferential wall portion 12 and lower circumferential wall portion 13 on both sides in the up-down direction, and is positioned in the up-down direction. As a result, upper drive coil 211, lower drive coil 212, and fixed yoke 214 can be positioned in the up-down direction.

Fixed yoke 214 has a function as a back yoke that restricts a passage (magnetic path) of a magnetic flux generated from movable magnet 31 to promote an electromagnetic interaction between a magnetic field of movable magnet 31 and an electric field of upper drive coil 211 and lower drive coil 212. In addition, fixed yoke 214 can also function as a magnetic spring together with movable magnet 31. That is, fixed yoke 214 is an example of a magnetic member provided in fixed body 20 to form, together with movable magnet 31, a magnetic spring that generates a magnetic force for biasing vibrating movable body 30 toward vibration center position VC. The magnetic spring forms a spring part in the spring-mass system together with leaf spring part 40 (upper leaf spring 41 and lower leaf spring 42) that functions as a support member in the present embodiment.

In the present embodiment, as shown in FIGS. 4C and 4D, length Lb1 of fixed yoke 214 in the up-down direction is shorter than length Lm1 of the movable range of movable body 30 in the up-down direction, and is longer than length (thickness) La1 of the movable-body main body of movable body 30 in the up-down direction.

In the present embodiment, since length Lb1 of fixed yoke 214 is shorter than length Lm1 of the movable range of movable body 30, characteristics of the magnetic spring, specifically, a spring constant thereof are variable. As a result, in the magnetic spring, a magnetic force generated in a case where a displacement of movable body 30 from vibration center position VC is large is smaller than a magnetic force generated in a case where the displacement of movable body 30 from vibration center position VC is small. Details of this action will be described later. Incidentally, a left side of FIG. 4D shows a state in which movable body 30 is at an upper limit position of the movable range, and a right side of FIG. 4D shows a state in which movable body 30 is at a lower limit position of the movable range.

### <Movable Body>

Movable body 30 constitutes a mass part in the spring-mass system in vibration actuator 1 that uses the resonance.

Movable body 30 is accommodated inside fixed body 20 and can vibrate linearly along the up-down direction inside fixed body 20. Movable body 30 is supported by the support member. In the present embodiment, the support member is composed of leaf spring part 40. Leaf spring part 40 includes upper leaf spring 41 and lower leaf spring 42. Movable body 30 is supported to vibrate linearly along the up-down direction by upper leaf spring 41 and lower leaf spring 42.

Movable body 30 includes movable magnet 31, main movable yokes 32 and 33, sub-movable yokes 34 and 35, and connection portions 36 and 37. Main movable yoke 32 and sub-movable yoke 34 are stacked in order on an upper surface of movable magnet 31, and main movable yoke 33 and sub-movable yoke 35 are stacked in order on a lower surface of movable magnet 31. Connection portions 36 and 37 constitute a central protruding portion that protrudes in both the upward and downward directions of movable body 30 at the central position in the radial direction, and are connected to inner circumferential portion 412 of upper leaf spring 41 and inner circumferential portion 422 of lower leaf spring 42 at distal end portions thereof, respectively.

Since a thrust force for vibrating movable body 30 is generated by an electromagnetic interaction with upper drive coil 211 and lower drive coil 212, movable magnet 31 is essential for movable body 30. In order to improve practicality of vibration actuator 1, it is preferable that movable body 30 includes main movable yokes 32 and 33 and connection portions 36 and 37, and it is more preferable that movable body 30 further includes sub-movable yokes 34 and 35, but main movable yokes 32 and 33, sub-movable yokes 34 and 35, and connection portions 36 and 37 are not necessarily essential in movable body 30. A configuration of the movable-body main body described below is an example.

### <Movable-Body Main Body>

Movable magnet 31, main movable yokes 32 and 33, and sub-movable yokes 34 and 35 are laminated in the up-down direction as described above to form an integrated movable-body main body. An outer diameter of the movable-body main body is slightly smaller than a minimum inner diameter of a tubular portion of fixed body 20 (specifically, a diameter of the inner circumferential surface of bobbin 213). As a result, a clearance is ensured between movable body 30 and fixed body 20, and movable body 30 can vibrate without coming into contact with the tubular portion of fixed body 20.

In the present embodiment, the outer diameter of the movable-body main body is constant over an entire length of the movable-body main body in the up-down direction. However, the outer diameter of the movable-body main body need not be constant in a case where an upper half portion and a lower half portion of movable body 30 have a shape that is symmetric with respect to a plane passing through an intermediate position of movable magnet 31 in the up-down direction.

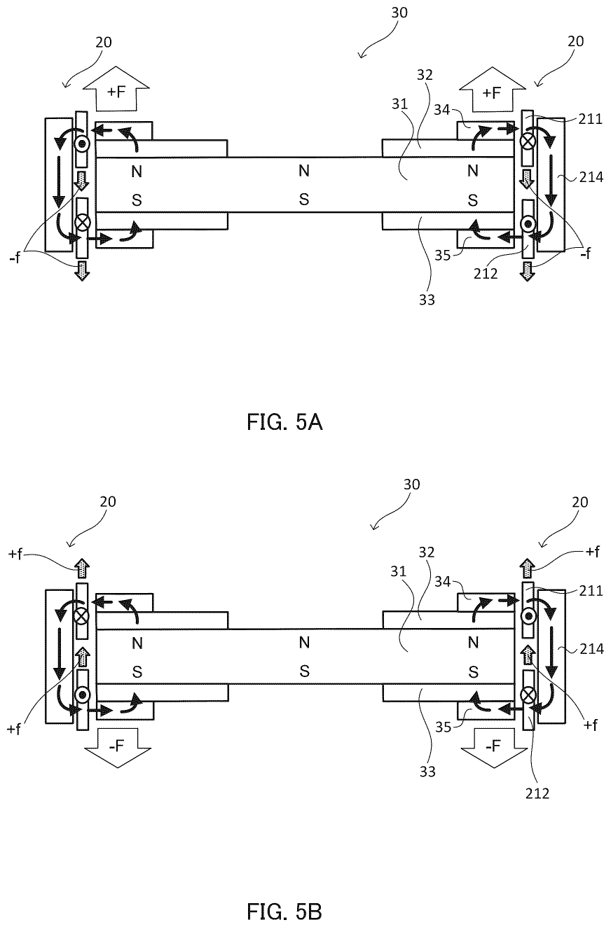

Movable magnet 31 is a permanent magnet magnetized in the up-down direction. For example, the upper surface and the lower surface of movable magnet 31 are magnetized to N-pole and S-pole, respectively (see FIG. 5A and the like). Movable magnet 31, together with upper drive coil 211 and lower drive coil 212, forms a motor (more specifically, a voice coil motor) that generates the thrust force for vibrating movable body 30. The vibration operation of movable body 30 by the driving of the motor will be described later. In addition, movable magnet 31 constitutes the magnetic spring in the spring part of the spring-mass system together with fixed yoke 214.

In the present embodiment, movable magnet 31 has a disk shape, and is disposed such that an upper plate surface (upper surface) and a lower plate surface (lower surface) of movable magnet 31 extend in a direction orthogonal to the up-down direction.

Main movable yokes 32 and 33 are made of a non-magnetized magnetic material. Main movable yokes 32 and 33 concentrate a magnetic flux of movable magnet 31, efficiently flow the magnetic flux without leakage, and promote the electromagnetic interaction between movable magnet 31 and upper drive coil 211 and lower drive coil 212. Main movable yokes 32 and 33 can be stacked and disposed on movable magnet 31 by, for example, adhesion to the upper surface and the lower surface of movable magnet 31.

In the present embodiment, main movable yokes 32 and 33 are annular plate-shaped members having a through-opening portion at a radially central position, but as a variation, main movable yokes 32 and 33 may be disk-shaped members having no through-opening portion. In the present embodiment, connection portions 36 and 37 are inserted into the through-opening portions of main movable yokes 32 and 33.

Sub-movable yokes 34 and 35 are made of a non-magnetized magnetic material. In addition, in the present embodiment, sub-movable yokes 34 and 35 are annular plate-shaped members having a through-opening portion that has a larger diameter than an opening diameter of the through-opening portions of main movable yoke 32 and 33. Sub-movable yokes 34 and 35 appropriately distribute the magnetic flux of movable magnet 31 concentrated in main movable yokes 32 and 33 toward upper drive coil 211 and lower drive coil 212, to promote the electromagnetic interaction between movable magnet 31 and upper drive coil 211 and lower drive coil 212. Sub-movable yokes 34 and 35 can be stacked and disposed on main movable yokes 32 and 33 by, for example, adhesion to an upper surface of main movable yoke 32 and a lower surface of main movable yoke 33, respectively. By adjusting a thickness (length in the up-down direction) and a width (a width in the radial direction between outer circumferential portions and inner circumferential portions of sub-movable yokes 34 and 35) of sub-movable yokes 34 and 35 as appropriate, a mass of movable body 30 can also be adjusted as appropriate.

Connection portions 36 and 37 connect the movable-body main body to upper leaf spring 41 and lower leaf spring 42. Connection portions 36 and 37 include insertion pins 361 and 371 and outer tubular portions 362 and 372, respectively. Insertion pins 361 and 371 and outer tubular portions 362 and 372 are formed of a non-magnetic and non-conductive resin material. Insertion pins 361 and 371 and outer tubular portions 362 and 372 are not limited to being non-magnetic and non-conductive, and may be formed of a magnetic and conductive material, or may be formed of, for example, brass (bronze).

Outer tubular portions 362 and 372 are mounted on the movable-body main body by, for example, inserting first end portions thereof into the through-opening portions of main movable yokes 32 and 33, respectively. Inner circumferential portions 412 and 422 of upper leaf spring 41 and lower leaf spring 42 make contact with second end portions of outer tubular portions 362 and 372. Insertion pins 361 and 371 have a smaller diameter than outer tubular portions 362 and 372, are inserted into outer tubular portions 362 and 372 from above and below, respectively, and are fixed to outer tubular portions 362 and 372.

Flanges are provided at an upper end portion of insertion pin 361 and a lower end portion of insertion pin 371, and inner circumferential portion 412 of upper leaf spring 41 is sandwiched between the upper end flange of insertion pin 361 and the second end portion of outer tubular portion 362. Similarly, inner circumferential portion 422 of lower leaf spring 42 is sandwiched between the lower end flange of insertion pin 371 and the second end portion of outer tubular portion 372.

### <Leaf Spring Part>

Leaf spring part 40 is an example of a support member that supports movable body 30. Leaf spring part 40 includes upper leaf spring 41 and lower leaf spring 42. Upper leaf spring 41 and lower leaf spring 42 include arm portions 411 and 421, inner circumferential portions 412 and 422, and outer circumferential portions 413 and 423, respectively.

Inner circumferential portions 412 and 422 are small-diameter annular portions and are connected to movable body 30. A connection configuration between inner circumferential portions 412 and 422 and connection portions 36 and 37 of movable body 30 is as described above.

Outer circumferential portions 413 and 423 are large-diameter annular portions and are connected to fixed body 20. In the present embodiment, outer circumferential portion 413 is sandwiched in the up-down direction between upper lid portion 11 and upper circumferential wall portion 12, and outer circumferential portion 423 is sandwiched in the up-down direction between lower lid portion 14 and lower circumferential wall portion 13.

Arm portions 411 and 421 connect inner circumferential portions 412 and 422 to outer circumferential portions 413 and 423. Arm portions 411 and 421 are flexible portions that can be bent in accordance with the vibration of movable body 30. In the present embodiment, since arm portions 411 and 421 extend in a spiral shape between inner circumferential portions 412 and 422 and outer circumferential portions 413 and 423, it is easy to ensure a movable stroke.

### [Operation of Vibration Actuator]

Hereinafter, an operation of vibration actuator 1 will be described.

In the situation shown in FIG. 5A, a current that, as seen in plan view from above, flows in a counterclockwise direction is input to upper drive coil 211, and a current that, as seen in plan view from above, flows in a clockwise direction is input to lower drive coil 212.

In this case, according to Fleming's left-hand rule, a downward thrust force −f (here, a minus sign indicates that the force is directed downward) acts on upper drive coil 211. Similarly, according to Fleming's left-hand rule, a downward Lorentz force −f also acts on lower drive coil 212. Since upper drive coil 211 and lower drive coil 212 are parts of fixed body 20 and cannot be moved, movable body 30 moves upward due to an upward thrust force +F (here, a plus sign indicates that the force is directed upward) acting on movable body 30 according to the law of action and reaction.

In the situation shown in FIG. 5B, a current that, as seen in plan view from above, flows in the clockwise direction is input to upper drive coil 211, and a current that, as seen in plan view from above, flows in the counterclockwise direction is input to lower drive coil 212.

In this case, according to Fleming's left-hand rule, an upward thrust force +f acts on upper drive coil 211. Similarly, according to Fleming's left-hand rule, an upward Lorentz force +f also acts on lower drive coil 212. Since upper drive coil 211 and lower drive coil 212 are parts of fixed body 20 and cannot be moved, movable body 30 moves downward due to a downward thrust force −F acting on movable body 30 according to the law of action and reaction.

In a case where an alternating (AC) driving current is input to upper drive coil 211 and lower drive coil 212, the situation shown in FIG. 5A and the situation shown in FIG. 5B are alternately repeated according to a frequency (driving frequency) of the driving current. That is, movable body 30 alternately repeats the upward movement and the downward movement. As a result, movable body 30 vibrates. In the present embodiment, since a direction in which the thrust force acts is the up-down direction, movable body 30 vibrates linearly in the up-down direction.

In the present embodiment, movable body 30 is elastically supported by upper leaf spring 41 and lower leaf spring 42. Therefore, in a case where movable body 30 moves upward or downward from vibration center position VC, bent upper leaf spring 41 and bent lower leaf spring 42 generate a restoring force that tends to restore the original shape and transmit the force to movable body 30. Movable body 30 is biased in an opposite direction by this force. That is, movable body 30 moves to return to vibration center position VC downward in a case of moving upward, or upward in a case of moving downward. Further, in the present embodiment, a magnetic attractive force acts between movable magnet 31 of movable body 30 and fixed yoke 214 of fixed body 20. In a case where movable body 30 vibrates, movable body 30 is biased by not only the above-described restoring force but also the magnetic attractive force, and moves to return to vibration center position VC.

In particular, in the present embodiment, as described above, length Lb1 of fixed yoke 214 having a tubular shape as a whole and having flat-shaped inner and outer circumferential surfaces is set to be shorter than length Lm1 of the movable range of movable body 30. As a result, a change occurs in the spring constant of the magnetic spring. This point will be described with reference to FIGS. 6A, 6B, and 6C. In FIGS. 6A, 6B, and 6C, an action generated at a timing when movable body 30 is driven upward as shown in FIG. 5A will be described as an example. Since an action generated at a timing when movable body 30 is driven downward can be understood without any ambiguity by only reversing the direction in which the force acts in the following description, the description thereof will be omitted here.

In the situation shown in FIG. 6A, movable body 30 is positioned at vibration center position VC. Movable body 30 shown in FIG. 6A may be movable body 30 in a non-vibrating state that starts moving upward from now, or may be movable body 30 in a vibrating state that is passing through vibration center position VC.

Although a magnetic attractive force always acts between movable body 30 and fixed yoke 214, there is no upward biasing and no downward biasing in a direction of the magnetic attractive force in a case where movable body 30 is at vibration center position VC. That is, movable body 30 at vibration center position VC is not biased in either the upward direction or the downward direction by the magnetic spring.

In the situation shown in FIG. 6B, movable body 30 is displaced upward slightly from vibration center position VC due to the driving caused by the energization (see FIG. 5A) of upper drive coil 211 and lower drive coil 212.

In this case, the magnetic attractive force acting between movable body 30 and fixed yoke 214 is biased in the upward direction. Fixed yoke 214 is attracted upward by the magnetic attractive force, but since fixed yoke 214 is a part of fixed body 20 and cannot be moved, a downward biasing force acts on movable body 30 according to the law of action and reaction.

In the situation shown in FIG. 6C, movable body 30 is displaced further upward from the position shown in FIG. 6B due to the driving.

In this case, the magnetic attractive force acting between movable body 30 and fixed yoke 214 is biased in the upward direction as in the situation shown in FIG. 6B, but since a facing area in which the outer circumferential surface of movable body 30 faces the inner circumferential surface of fixed yoke 214 is reduced, the amount of magnetic flux connecting movable body 30 and fixed yoke 214 is reduced (leakage magnetic flux is increased), and the magnetic attractive force acting between movable body 30 and fixed yoke 214 is reduced, the downward biasing force acting on movable body 30 is reduced.

That is, in the series of operations exemplified in FIGS. 6A, 6B, and 6C, the spring constant of the magnetic spring decreases as vibrating movable body 30 deviates from vibration center position VC.

In a case where the spring constant of the magnetic spring decreases, a composite spring constant also decreases. The composite spring constant is determined by Equation 1.

$$[ 1 ]$$

$${K}_{sp} ( x ) = {k}_{mec} + {k}_{mag} ( x ) \qquad ( Equation 1 )$$

k_{mec}: spring constant of leaf spring part [N/m]
k_{mag}(x): spring constant of magnetic spring [N/m]

As shown in Equation 1, in the present embodiment, the spring constant of the magnetic spring depends on the amplitude, and accordingly, the composite spring constant of the spring part in the spring-mass system also depends on the amplitude.

In addition, according to Equation 2 below, in a case where the composite spring constant decreases as the amplitude increases, the resonance frequency of movable body 30 also decreases as the amplitude increases.

$$[ 2 ]$$

$${F}_{r} = \frac{1}{2 π} \sqrt{\frac{{K}_{sp} ( x )}{m}} \qquad ( Equation 2 )$$

Fᵣ: resonance frequency [Hz]
m: Mass [kg]
Kₛₚ(x): composite spring constant [N/m]

Here, the equation of motion and the circuit equation showing the driving principle of vibration actuator 1 are shown below. Vibration actuator 1 is driven based on the equation of motion represented by Equation 3 and the circuit equation represented by Equation 4.

$$[ 3 ]$$

$$m \frac{{d}^{2} x ( t )}{{dt}^{2}} = {K}_{f} i ( t ) - {K}_{sp} ( x ) \cdot x ( t ) - D \frac{dx ( t )}{dt} \qquad ( Equation 3 )$$

m: Mass [kg]
x(t): Displacement [m]
K_{f}: thrust force constant [N/A]
i(t): Current [A]
Kₛₚ(x): composite spring constant [N/m]
D: Damping coefficient [N/(m/s)]

$$[ 4 ]$$

$$e ( t ) = Ri ( t ) + L \frac{di ( t )}{dt} + {K}_{e} \frac{dx ( t )}{dt} \qquad ( Equation 4 )$$

e(t): Voltage [V]
R: Resistance [Q]
i(t): Current [A]
L: Inductance [H]
Kₑ: reverse electromotive force constant [V/(rad/s)]
x(t): Displacement [m]

That is, mass m [kg], displacement x(t) [m], thrust force constant K_{f}[N/A], current i(t) [A], composite spring constant Kₛₚ(x) [N/m], damping coefficient D [N/(m/s)], and the like in vibration actuator 1 can be appropriately changed as long as Equation 3 is satisfied. In addition, voltage e(t) [V], resistance R [Ω], inductance L [H], and reverse electromotive force constant Kₑ[V/(rad/s)] can be appropriately changed as long as Equation 4 is satisfied.

In a case where an alternating current (AC) wave having a frequency equal to the resonance frequency of movable body 30 is input to upper drive coil 211 and lower drive coil 212, movable body 30 enters a resonance state. That is, by inputting an alternating current (AC) wave having a frequency substantially equal to the resonance frequency of movable body 30 from a power supply part to upper drive coil 211 and lower drive coil 212, movable body 30 can be efficiently vibrated.

In a case where vibration actuator 1 satisfies Equations 3 and 4 and is driven by using a resonance phenomenon at the resonance frequency shown in Equation 2, movable body 30 can be vibrated linearly with low power consumption. In addition, in a case where the damping coefficient is increased, the vibration can be generated over a wide band.

In addition, as described above, in the present embodiment, the magnetic attractive force generated by the magnetic spring is reduced by the setting of length Lb1 of fixed yoke 214, since the magnetic flux between movable body 30 and fixed yoke 214 decreases as the amplitude of vibrating movable body 30 increases (in other words, as vibrating movable body 30 deviates from vibration center position VC in the upward and downward directions). This means that the spring constant of the magnetic spring described above decreases as vibrating movable body 30 deviates from vibration center position VC in the upward and downward directions. In a case where the spring constant of the magnetic spring is decreased, the composite spring constant of the spring part is also decreased. In a case where the spring constant (composite spring constant described above) of the spring part in the spring-mass system is decreased, the resonance frequency of the mass portion in the spring-mass system is decreased as shown in Equation 2.

The phenomenon in which “the amplitude of vibrating movable body 30 increases” described above occurs in a case where the frequency (driving frequency) of the alternating current (AC) input to upper drive coil 211 and lower drive coil 212 is decreased. This is because, in a case where the driving frequency is low, a wavelength of a current waveform is long, and thus a time during which vibrating movable body 30 moves upward/downward is long, and as a result, a distance during which movable body 30 moves upward/downward is long.

On the contrary, the phenomenon in which the amplitude of vibrating movable body 30 is decreased occurs in a case where the frequency (driving frequency) of the alternating current (AC) input to upper drive coil 211 and lower drive coil 212 is increased. This is because, in a case where the driving frequency is high, the wavelength of the current waveform is short, and thus the time during which vibrating movable body 30 moves upward/moves downward is short, and as a result, the distance during which movable body 30 moves upward/moves downward is short.

In short, in a case where the driving frequency of upper drive coil 211 and lower drive coil 212 is decreased, the resonance frequency is decreased, and in a case where the driving frequency of upper drive coil 211 and lower drive coil 212 is increased, the resonance frequency is increased. Therefore, since the resonance frequency changes in the same direction as a direction in which the driving frequency changes, the frequency bandwidth in which the output of the desired vibration intensity is possible is widened (also referred to as broadband or wideband operation).

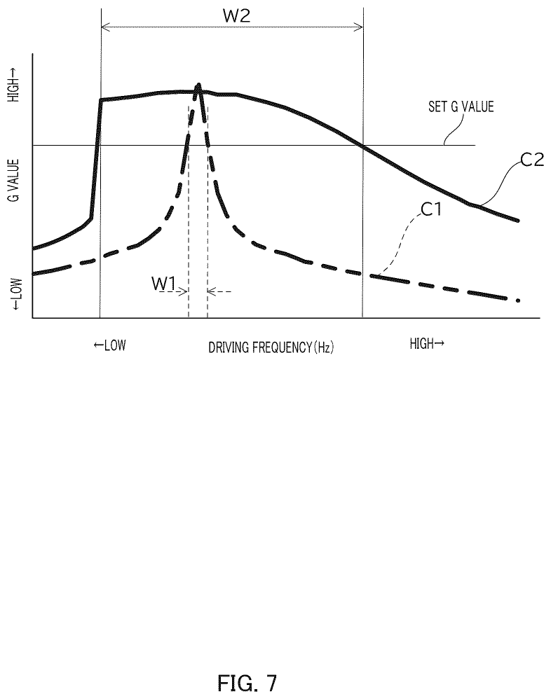

Frequency characteristics of vibration actuator 1 in this case are shown by frequency characteristic curve C2 in FIG. 7. In frequency characteristic curve C2, frequency bandwidth W2 in which the vibration having a desired vibration intensity (set G value) or more can be ensured is wider than frequency bandwidth W1 of normal frequency characteristic curve C1. That is, the frequency bandwidth in which the output of the desired vibration intensity is possible is widened.

Therefore, even in a case where individual differences occur in the resonance frequency of vibration actuator 1 due to individual differences or the like of a product, and a mismatch occurs or is increased between the resonance frequency and a predetermined driving frequency for vibration actuator 1, it is easy to ensure the output of the desired vibration intensity. That is, the frequency bandwidth in which the output of the desired vibration intensity is possible can be widened. In addition, in order to achieve this effect, a special configuration or control such as providing a dedicated circuit for detecting the resonance frequency is not necessary. Therefore, it is possible to reduce the size of vibration actuator 1 or the mounting apparatus thereof, to suppress the manufacturing cost, or to suppress the power consumption.

FIGS. 8 and 9 show examples of an electric device on which a vibration actuator equivalent to vibration actuator 1 is mounted. FIG. 8 shows an example in which vibration actuator 1 is mounted on game controller GC, and FIG. 9 shows an example in which vibration actuator 1 is mounted on mobile terminal M.

Game controller GC is connected to a game machine body by, for example, wireless communication and is used by being gripped or held by the user. Here, game controller GC has a rectangular plate shape, and the user performs an operation of gripping both left and right sides of game controller GC with both hands.

Game controller GC notifies the user of a command from the game machine body by vibration. Although not shown, game controller GC has a function other than the command notification, and includes, for example, an input operation part for the game machine body.

Mobile terminal M is, for example, a mobile communication terminal such as a mobile phone or a smartphone. Mobile terminal M notifies the user of an incoming call from an external communication apparatus by vibration and realizes each function of mobile terminal M (for example, a function of providing an operation feeling or presence).

Each of game controller GC and mobile terminal M includes communication section 5201, processing section 5202, drive control section 5203, and vibration actuators 5204, 5205, and 5206 that are equivalent to vibration actuator 1 as a driving part. As in the example of game controller GC, a plurality of vibration actuators 5204 and 5205 may be mounted.

In game controller GC and mobile terminal M, it is preferable that vibration actuators 5204 to 5206 are mounted such that, for example, a main surface of the terminal and a surface orthogonal to a vibration direction of vibration actuators 5204 to 5206 (here, the bottom surface of lower lid portion 14) are parallel to each other.

The main surface of the terminal is a surface that comes into contact with a body surface of the user, and in the present embodiment, means a vibration transmission surface that comes into contact with the body surface of the user to transmit vibration. The terminal main surface and the bottom surface of lower lid portion 14 of vibration actuators 5204, 5205, and 5206 may be disposed to be orthogonal to each other.

Specifically, in game controller GC, vibration actuators 5204 and 5205 are mounted such that the vibration direction is orthogonal to a surface that is in contact with a fingertip, a palm, or a hand of the user who operates game controller GC, or a surface on which an operation part is provided. In addition, in a case of mobile terminal M, vibration actuator 5206 is mounted such that the vibration direction is orthogonal to a display screen (touch panel surface). As a result, the vibration in a direction perpendicular to the main surface of game controller GC and mobile terminal M is transmitted to the user.

Communication section 5201 is connected to the external communication apparatus by wireless communication and receives a signal from the communication apparatus to output the signal to processing section 5202. In a case of game controller GC, the external communication apparatus is the game machine body as an information communication terminal, and communication is performed in accordance with a short-range wireless communication standard such as Bluetooth (registered trademark). In a case of mobile terminal M, the external communication apparatus is, for example, a base station, and communication is performed in accordance with a mobile communication standard.

Processing section 5202 converts the input signal into a drive signal for driving vibration actuators 5204, 5205, and 5206 by a conversion circuit unit (not shown) and outputs the drive signal to drive control section 5203. In mobile terminal M, processing section 5202 generates the drive signal based on a signal input from various functional units (not shown, for example, an operation part such as a touch panel) in addition to the signal input from communication section 5201.

Drive control section 5203 is connected to vibration actuators 5204, 5205, and 5206, and a circuit for driving vibration actuators 5204, 5205, and 5206 is mounted on drive control section 5203. Drive control section 5203 supplies the drive signal to vibration actuators 5204, 5205, and 5206.

Vibration actuators 5204, 5205, and 5206 are driven according to the drive signal from drive control section 5203. Specifically, in vibration actuators 5204, 5205, and 5206, movable body 30 vibrates in a direction orthogonal to the main surface of game controller GC and mobile terminal M.

Since the vibration in the direction perpendicular to the body surface is transmitted to the body surface of the user in contact with game controller GC or mobile terminal M, it is possible to provide sufficient haptic vibration to the user. In game controller GC, the haptic vibration to the user can be applied by one or both of vibration actuators 5204 and 5205, and vibration with a high expressiveness in which at least the vibration of a strong or weak degree can be selectively applied can be applied.

Vibration actuator 1 is effective in a case of being mounted on a contact portion with the user in a handheld electric device such as a mobile terminal or an electric grooming and beauty apparatus such as a facial massage device. The same applies to a wearable terminal that is worn and used by the user. The contact portion with the user is, for example, a handle portion that is gripped by the user in a case of using the handheld electric device such as game controller GC, and is, for example, a pressurizing portion that pressurizes the body surface of the user in a case of the wearable electric device such as the facial massage device.

### Embodiment 2

Hereinafter, Embodiment 2 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

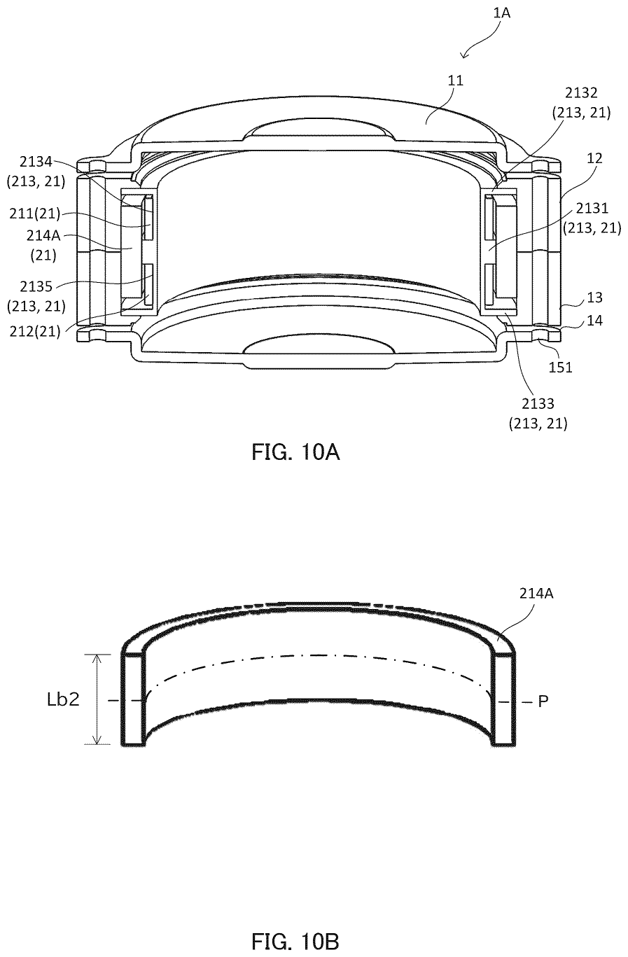

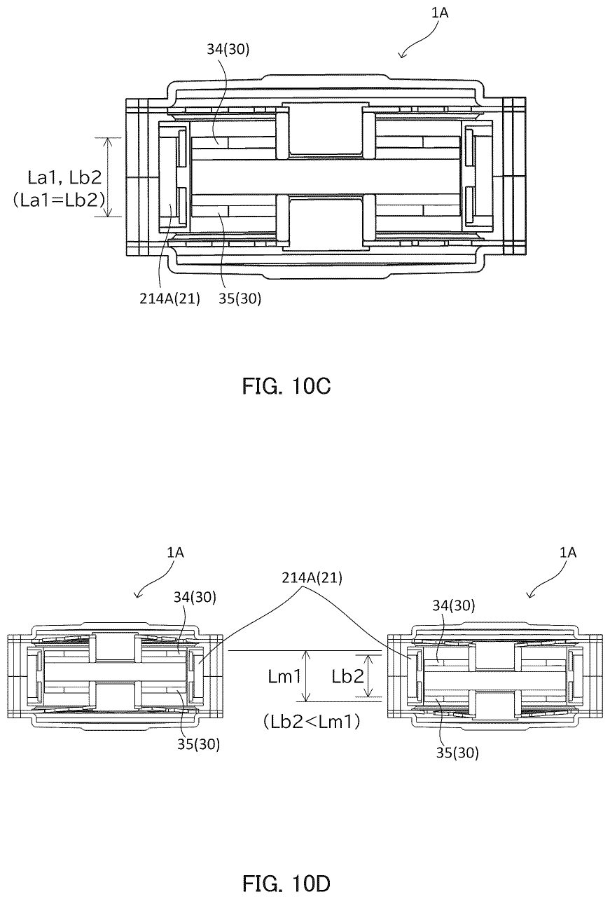

In vibration actuator 1A according to the present embodiment, as shown in FIGS. 10C and 10D, length Lb2 of fixed yoke 214A in the up-down direction is shorter than length Lm1 of the movable range of movable body 30 in the up-down direction, and is equal to length La1 of the movable-body main body of movable body 30 in the up-down direction. Fixed yoke 214A of the present embodiment is different from fixed yoke 214 of Embodiment 1 in terms of the length in the up-down direction, but is common in the other points.

As a result, in the present embodiment, the same effect as that of Embodiment 1 can be achieved. In particular, in the present embodiment, since length Lb2 of fixed yoke 214A in the up-down direction is equal to length La1 of the movable-body main body of movable body 30 in the up-down direction, it is possible to achieve an effect of widening the frequency bandwidth in which the desired vibration intensity can be output even with a smaller amplitude. Incidentally, a left side of FIG. 10D shows a state in which movable body 30 is at an upper limit position of the movable range, and a right side of FIG. 10D shows a state in which movable body 30 is at a lower limit position of the movable range.

### Embodiment 3

Hereinafter, Embodiment 3 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

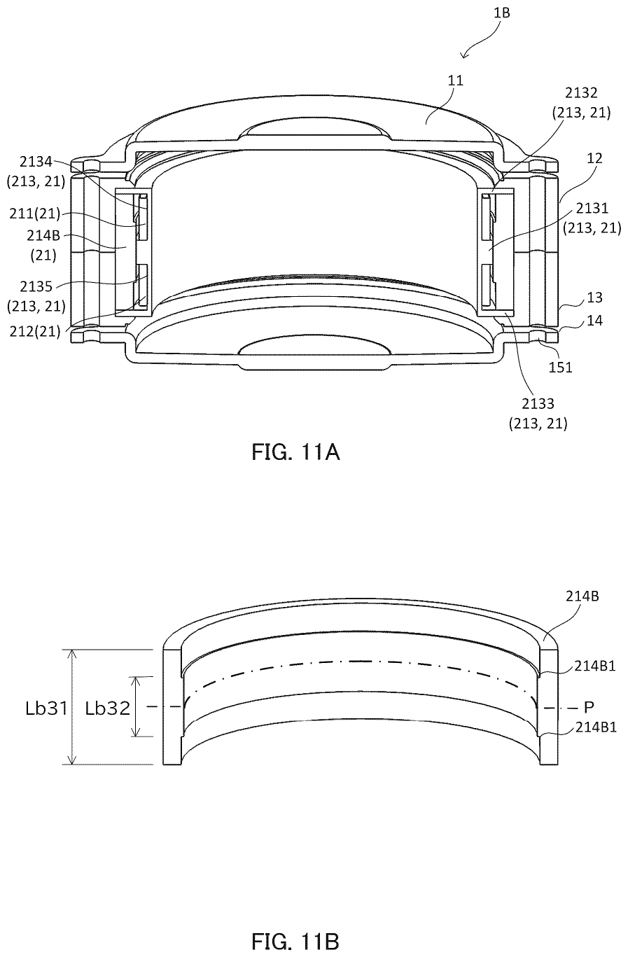

In vibration actuator 1B according to the present embodiment, as shown in FIGS. 11A and 11B, the inner circumferential surface of fixed yoke 214B includes inner stepped portion 214B1 in which an inner diameter is changed. As a result, in fixed yoke 214B, inner diameters of both end portions in the up-down direction are larger than the inner diameter of intermediate portion P. In other words, the inner circumferential surface of fixed yoke 214B is convex inward at intermediate portion P. In fixed yoke 214B, length Lb31 between the both end portions in the up-down direction may be equal to or longer than length Lm1 of the movable range of movable body 30 in the up-down direction. Fixed yoke 214B of the present embodiment is common to fixed yoke 214 of Embodiment 1 except for the above-described points.

As a result, in the present embodiment, it is possible to achieve an effect of making the change (decrease) in the spring constant of the magnetic spring in a case where movable body 30 moves in the up-down direction more significant than that of Embodiment 1.

In addition, since an outer circumferential surface of fixed yoke 214B of the present embodiment is a flat surface without unevenness or inclination, a large adhesive area can be ensured, for example, in a case of adhering to case 10 disposed on the outside.

### Embodiment 4

Hereinafter, Embodiment 4 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

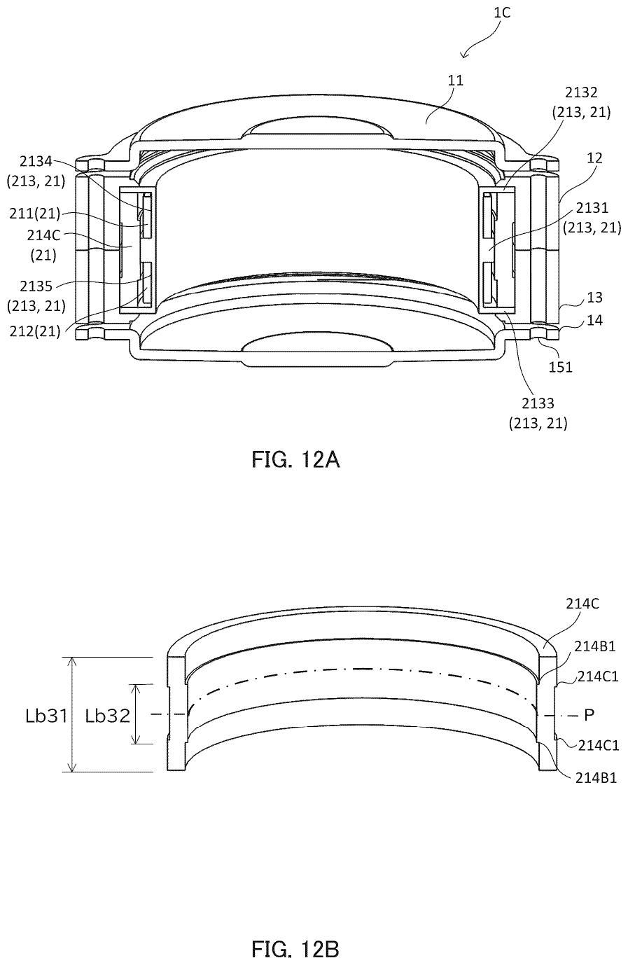

In vibration actuator 1C according to the present embodiment, as shown in FIGS. 12A and 12B, the outer circumferential surface of fixed yoke 214C includes outer stepped portion 214C1 in which an outer diameter is changed. As a result, in fixed yoke 214C, outer diameters of both end portions in the up-down direction are larger than the outer diameter of intermediate portion P. In other words, the outer circumferential surface of fixed yoke 214C is convex inward at intermediate portion P. Fixed yoke 214C of the present embodiment is common to fixed yoke 214B of Embodiment 3 except for the above-described points.

As a result, in the present embodiment, it is possible to achieve an effect of making the change (decrease) in the spring constant of the magnetic spring in a case where movable body 30 moves in the up-down direction more significant than that of Embodiment 1.

### Embodiment 5

Hereinafter, Embodiment 5 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

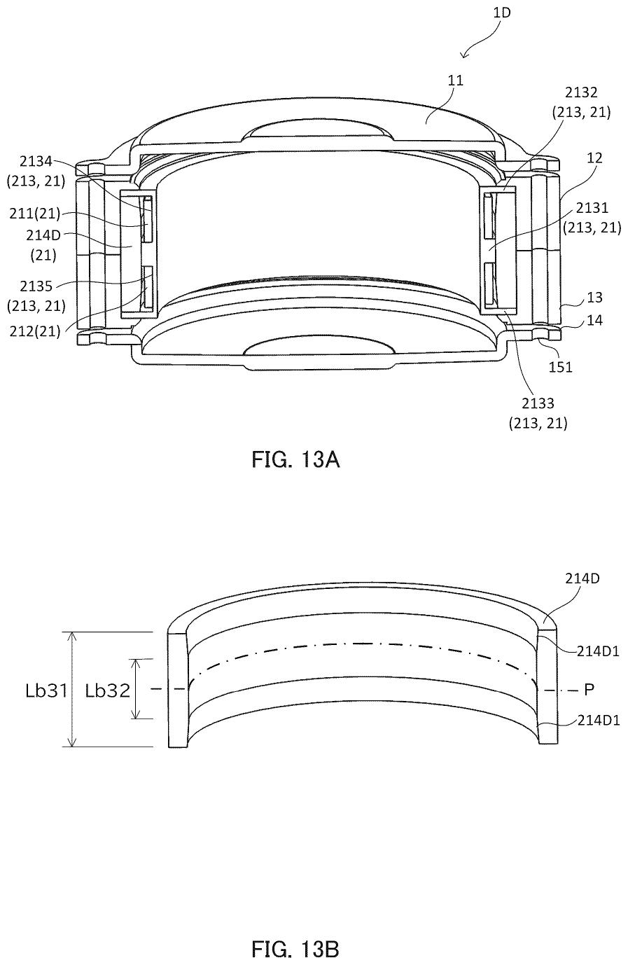

In vibration actuator 1D according to the present embodiment, as shown in FIGS. 13A and 13B, the inner circumferential surface of fixed yoke 214D includes inclined inner circumferential surface (an example of an inclined portion) 214D1 in which the inner diameter gradually increases from intermediate portion P to the portions of both end portions in the up-down direction. As a result, in fixed yoke 214D, the inner diameters of both end portions in the up-down direction are larger than the inner diameter of intermediate portion P. In other words, the inner circumferential surface of fixed yoke 214D is convex inward at intermediate portion P. In fixed yoke 214D, length Lb31 between the both end portions in the up-down direction may be equal to or longer than length Lm1 of the movable range of movable body 30 in the up-down direction. Fixed yoke 214D of the present embodiment is common to fixed yoke 214B of Embodiment 3 except for the above-described points.

As a result, in the present embodiment, it is possible to achieve an effect of making the change (decrease) in the spring constant of the magnetic spring in a case where movable body 30 moves in the up-down direction more significant than that of Embodiment 1.

In addition, since an outer circumferential surface of fixed yoke 214D of the present embodiment is a flat surface without unevenness or inclination, a large adhesive area can be ensured, for example, in a case of adhering to case 10 disposed on the outside.

In addition, since the inner diameter of fixed yoke 214D of the present embodiment is gradually increased in inclined inner circumferential surface 214D1, the spring constant of the magnetic spring can be more gently decreased.

### Embodiment 6

Hereinafter, Embodiment 6 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

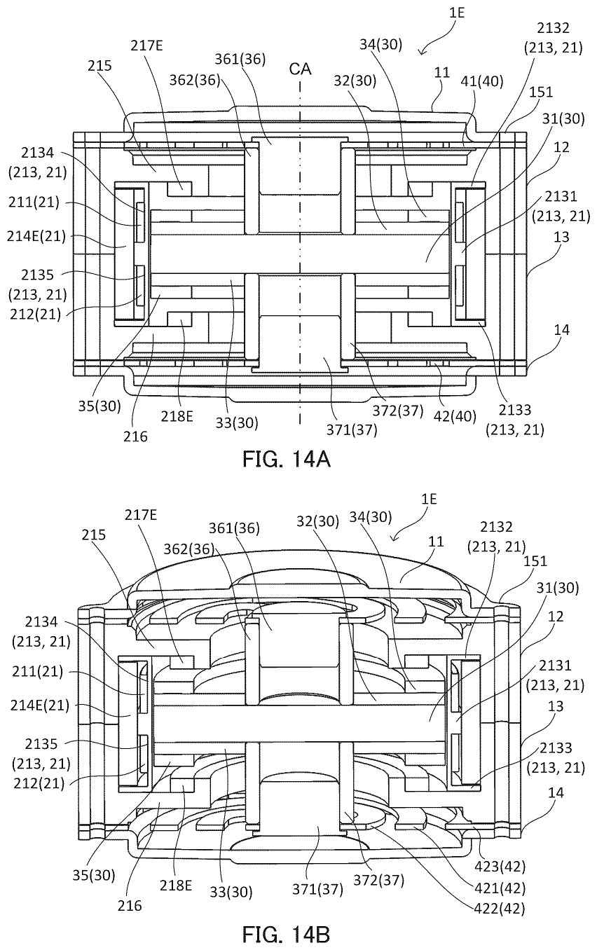

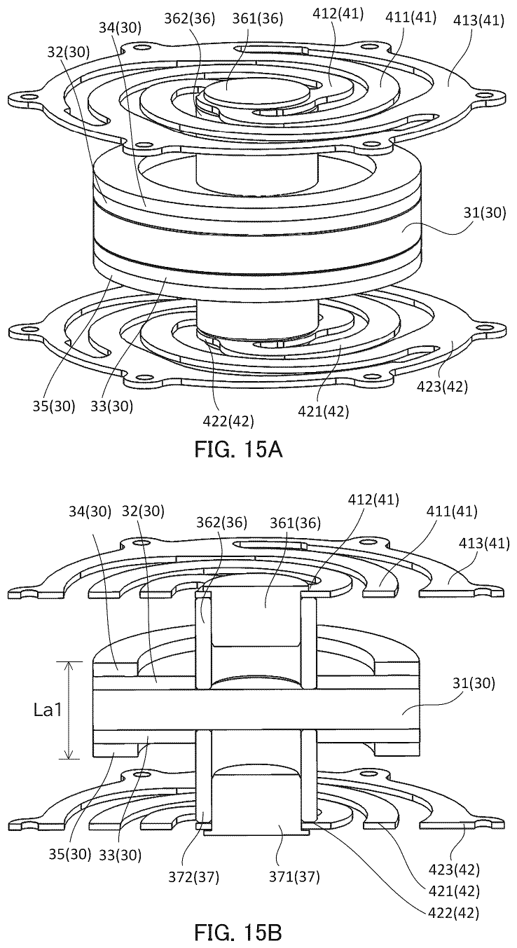

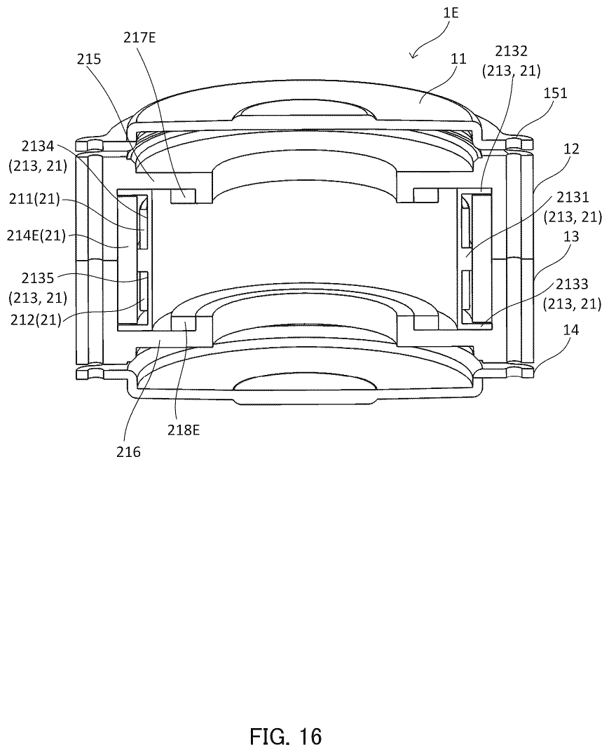

FIG. 14A is a side sectional view of a vibration actuator according to the present embodiment, and FIG. 14B is a perspective sectional view of the vibration actuator according to the present embodiment. FIG. 15A is a perspective view of a movable body on which a leaf spring is mounted in the vibration actuator according to the present embodiment, and FIG. 15B is a perspective sectional view of the movable body shown in FIG. 15A. FIG. 16 is a perspective sectional view of a fixed body of the vibration actuator according to the present embodiment.

In vibration actuator 1E according to the present embodiment, fixed body 20 includes fixed magnets 217E and 218E that are held by magnetic member holding portions 215 and 216 to face movable magnet 31, more specifically, sub-movable yokes 34 and 35 covering movable magnet 31, in the up-down direction.

Magnetic member holding portions 215 and 216 are configured such that portions of upper circumferential wall portion 12 and lower circumferential wall portion 13 that sandwich drive coil assembly 21 from both sides in the up-down direction extend inward at positions closer to movable body 30 than upper leaf spring 41 and lower leaf spring 42 are to the movable body. Fixed magnets 217E and 218E are permanent magnets magnetized in the up-down direction in advance. Fixed magnets 217E and 218E are magnetized such that polarities of end portions facing movable magnet 31 are opposite to polarities of facing surfaces of movable magnet 31. As a result, a magnetic attractive force is always generated between fixed magnets 217E and 218E and movable body 30 (movable magnet 31).

Fixed magnets 217E and 218E are disposed on surfaces of magnetic member holding portions 215 and 216 that face movable body 30. In the present embodiment, fixed magnets 217E and 218E extend annularly to face annular sub-movable yokes 34 and 35 over the entire circumference. Fixed magnets 217E and 218E are examples of the magnetic member provided in fixed body 20 to form the magnetic spring, together with movable magnet 31, that generates a magnetic force for biasing vibrating movable body 30 toward vibration center position VC.

As described above, in the present embodiment, fixed magnets 217E and 218E and magnetic member holding portions 215 and 216 are interposed between movable body 30 and each of upper leaf spring 41 and lower leaf spring 42 in the up-down direction. Therefore, connection portion 36 of movable body 30 is slightly long in the up-down direction, and entire vibration actuator 1 is also slightly long in the up-down direction. However, in the present embodiment, the length of the movable-body main body of movable body 30 in the up-down direction is La1, as in the above-described embodiments. In addition, the length of the movable range of movable body 30 in the up-down direction is Lm1 as in the above-described embodiments.

On the other hand, in fixed body 20, the length of fixed yoke 214E in the up-down direction may be equal to or longer than length Lm1 of the movable range of movable body 30 in the up-down direction. In addition, an inner diameter of fixed yoke 214E may be the same over the entire length in the up-down direction. With the setting of the dimensions and the shape of fixed yoke 214E as described above, in the present embodiment, an effect of varying the spring constant of the magnetic spring is not exhibited between fixed yoke 214E and movable magnet 31. As described above, in the present embodiment, the effect is exhibited by fixed magnets 217E and 218E.

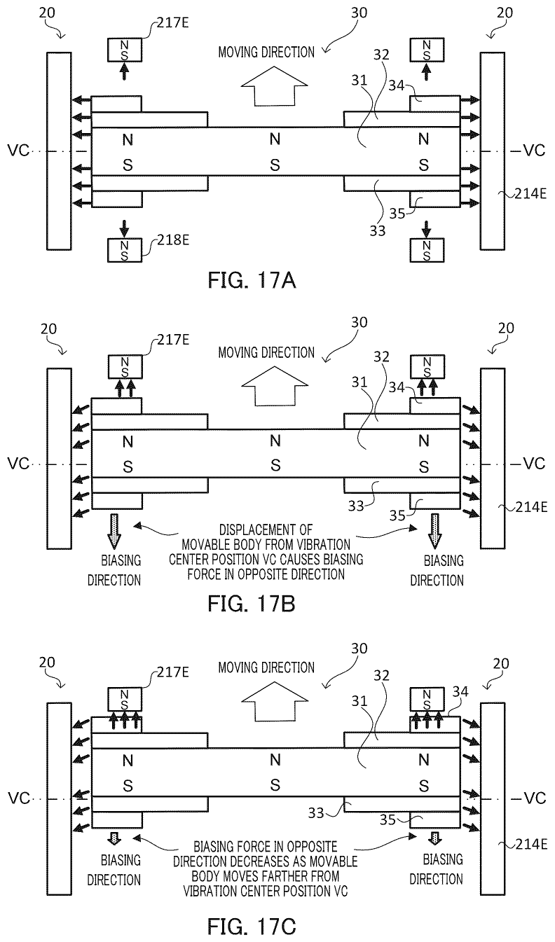

This point will be described with reference to FIGS. 17A, 17B, and 17C. In FIGS. 17A, 17B, and 17C, an action generated at a timing when movable body 30 is driven upward as shown in FIG. 5A will be described as an example. Since an action generated at a timing when movable body 30 is driven downward can be understood without any ambiguity by only reversing the direction in which the force acts in the following description, the description thereof will be omitted here.

In the situation shown in FIG. 17A, movable body 30 is positioned at vibration center position VC. Movable body 30 shown in FIG. 17A may be movable body 30 in a non-vibrating state that starts moving upward from now, or may be movable body 30 in a vibrating state that is passing through vibration center position VC.

In a case where movable body 30 is at vibration center position VC, there is no upward biasing and no downward biasing in the direction of the magnetic attractive force a magnetic attractive force always acting between movable body 30 and fixed yoke 214E. In addition, in a case where movable body 30 is at vibration center position VC, the magnetic attractive force between upper fixed magnet 217E and movable magnet 31 and the magnetic attractive force between lower fixed magnet 218E and movable magnet 31 are balanced. That is, movable body 30 at vibration center position VC is not biased in either the upward direction or the downward direction by the magnetic spring.

In the situation shown in FIG. 17B, movable body 30 is displaced upward slightly from vibration center position VC due to the driving caused by the energization (see FIG. 5A) of upper drive coil 211 and lower drive coil 212.

In this case, the magnetic attractive force acting between movable body 30 and fixed yoke 214 is biased in the upward direction. Fixed yoke 214E is attracted upward by the magnetic attractive force, but since fixed yoke 214E is a part of fixed body 20 and cannot be moved, a downward biasing force acts on movable body 30 according to the law of action and reaction. In this case, the magnetic attractive force between upper fixed magnet 217E and movable magnet 31 is increased by bringing the two magnets close to each other, while the magnetic attractive force between lower fixed magnet 218E and movable magnet 31 is reduced by separation of the two magnets from each other. Therefore, the direction of the magnetic attractive force between fixed magnets 217E and 218E and movable magnet 31 is biased in the upward direction. Due to the occurrence of the biasing in the upward direction, the downward biasing force acting on movable body 30 is slightly reduced.

In the situation shown in FIG. 17C, movable body 30 is displaced further upward from the position shown in FIG. 17B due to the driving.

In this case, the magnetic attractive force acting between movable body 30 and fixed yoke 214E is substantially the same as in the situation shown in FIG. 17B. On the other hand, the magnetic attractive force between upper fixed magnet 217E and movable magnet 31 is further increased by further bringing the two magnets close to each other, while the magnetic attractive force between lower fixed magnet 218E and movable magnet 31 is further reduced by further separation of the two magnets from each other. Therefore, the upward magnetic attractive force acting between fixed magnets 217E and 218E and movable magnet 31 is increased. The downward biasing force acting on movable body 30 is further reduced by the increased upward magnetic attractive force, and is reduced as compared with the situation shown in FIG. 17B.

That is, in the series of operations exemplified in FIGS. 17A, 17B, and 17C, the spring constant of the magnetic spring decreases as vibrating movable body 30 deviates from vibration center position VC. In a case where the spring constant of the magnetic spring decreases as the amplitude increases, the composite spring constant also decreases, and in a case where the composite spring constant decreases, the resonance frequency of movable body 30 also decreases.

In addition, in a case where the driving frequency of upper drive coil 211 and lower drive coil 212 decreases, the resonance frequency decreases, and in a case where the driving frequency of upper drive coil 211 and lower drive coil 212 increases, the resonance frequency increases. Therefore, since the resonance frequency changes in the same direction as a direction in which the driving frequency changes, the frequency bandwidth in which the output of the desired vibration intensity is possible is widened. This point is as described in detail in the description of Embodiment 1.

### Embodiment 7

Hereinafter, Embodiment 7 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

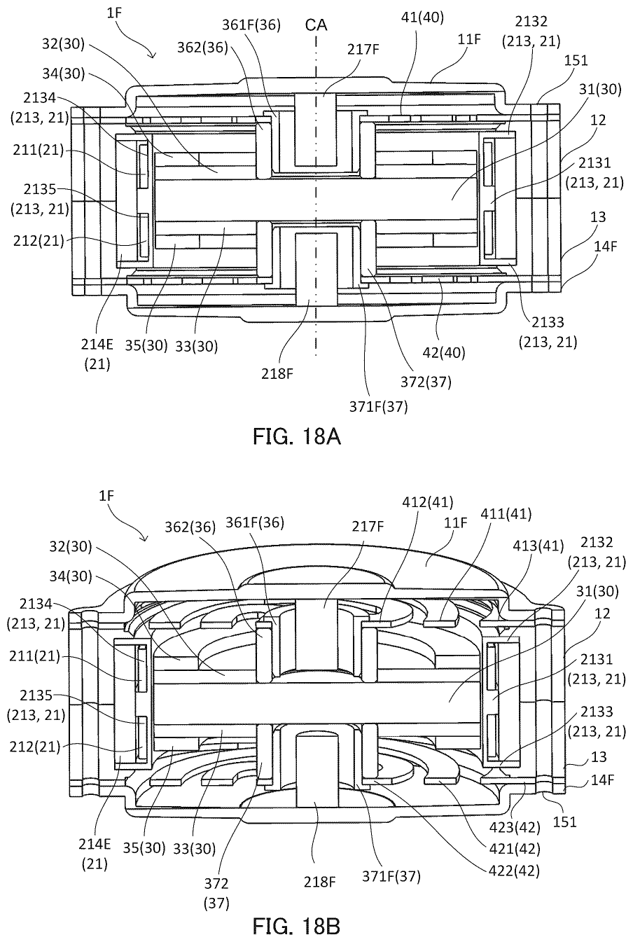

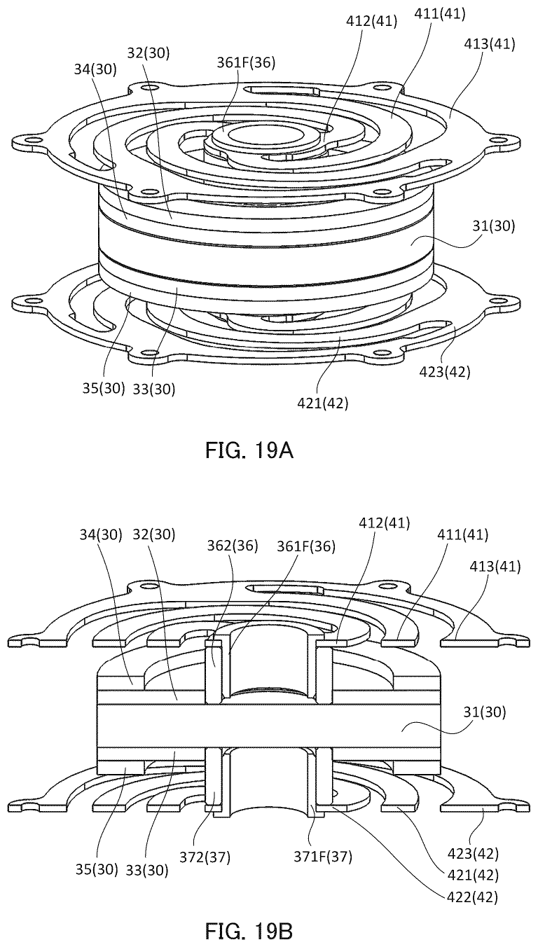

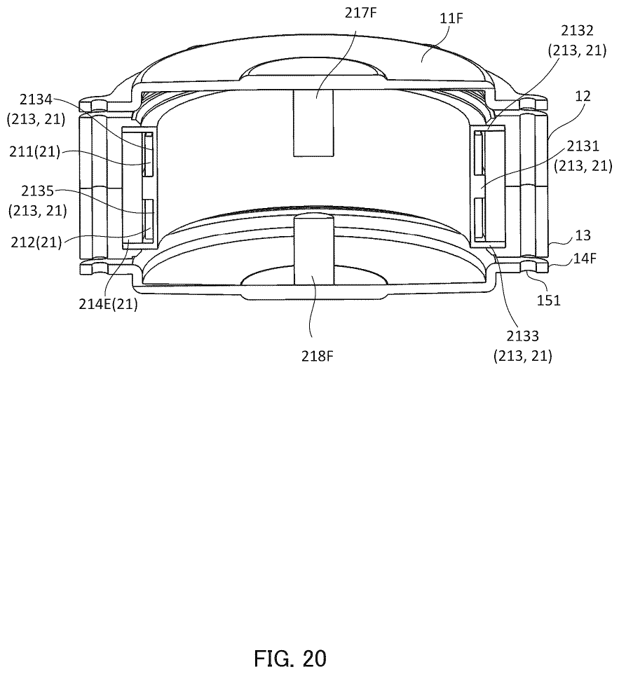

FIG. 18A is a side sectional view of a vibration actuator according to the present embodiment, and FIG. 18B is a perspective sectional view of the vibration actuator according to the present embodiment. FIG. 19A is a perspective view of a movable body on which a leaf spring is mounted in the vibration actuator according to the present embodiment, and FIG. 19B is a perspective sectional view of the movable body shown in FIG. 19A. FIG. 20 is a perspective sectional view of a fixed body of the vibration actuator according to the present embodiment.

In vibration actuator 1F according to the present embodiment, fixed body 20 includes fixed magnets 217F and 218F that are held by upper lid portion 11F and lower lid portion 14F, respectively, to face movable body 30, specifically, both the upper and lower surfaces of movable magnet 31 in the up-down direction. Fixed magnets 217F and 218F are examples of the magnetic member provided in fixed body 20 to constitute a magnetic spring, together with movable magnet 31, that generates a magnetic force for biasing vibrating movable body 30 toward vibration center position VC. In the present embodiment, upper lid portion 11F and lower lid portion 14F are configured to function as the magnetic member holding portion that holds the magnetic member.

Fixed magnets 217F and 218F are permanent magnets magnetized in the up-down direction in advance. Fixed magnets 217F and 218F are magnetized such that polarities of end portions facing movable magnet 31 are opposite to polarities of facing surfaces of movable magnet 31. As a result, a magnetic attractive force is always generated between fixed magnets 217F and 218F and movable body 30 (movable magnet 31).

Fixed magnets 217F and 218F are disposed on surfaces of upper lid portion 11F and lower lid portion 14F that face movable body 30. In the present embodiment, fixed magnets 217F and 218F extend in a rod shape to approach the upper surface and the lower surface of movable magnet 31 from both the upward and downward directions at a central portion in the radial direction so as to face portions of the upper surface and the lower surface of movable magnet 31 that are not covered with other members and that are open upward and downward.

As described above, in the present embodiment, fixed magnets 217F and 218F extend from upper lid portion 11F and lower lid portion 14F to positions close to the upper surface and the lower surface of movable magnet 31. Therefore, in the present embodiment, in connection portions 36 and 37 that respectively connect movable body 30 to upper leaf spring 41 and lower leaf spring 42, insertion members to be inserted into outer tubular portions 362 and 372 have a tubular shape (inner tubular portions 361F and 371F). As a result, fixed magnets 217F and 218F can reach the positions facing the upper surface and the lower surface of movable body 30 (movable magnet 31) by passing through central opening portions of inner circumferential portions 412 and 422 of upper leaf spring 41 and lower leaf spring 42 from upper lid portion 11F and lower lid portion 14F to which the fixed magnets are fixed, respectively. However, fixed magnets 217F and 218F do not extend to positions at which fixed magnets 217F and 218F can come into contact with movable body 30 (movable magnet 31), so as not to hinder the vibration operation of movable body 30. Further, the positions facing the upper surface and the lower surface of movable body 30 (movable magnet 31) are, for example, positions (positions overlapping in the up-down direction) corresponding to positions, in the up-down direction, at which upper drive coil 211 and lower drive coil 212 are disposed. In addition, inner tubular portions 361F and 371F have a slightly larger diameter than outer diameter of fixed magnets 217F and 218F disposed in the hollow portions, and a clearance that, during vibration of movable body 30, suppresses or prevents contact between inner tubular portions 361F and 371F and fixed magnets 217F and 218F is ensured.

Inner tubular portions 361F and 371F have a configuration common to solid insertion pins 361 and 371 of each of the above-described embodiments except that inner tubular portions 361F and 371F have a tubular shape.

The present embodiment is the same as Embodiment 6 in that an effect of varying the spring constant of the magnetic spring is not exhibited between fixed yoke 214E and movable magnet 31. As described above, in the present embodiment, the effect is exhibited by fixed magnets 217F and 218F. Since the principle by which this effect is exhibited is the same as the principle described with reference to FIGS. 17A, 17B, and 17C in Embodiment 6, the detailed description thereof will be omitted here.

In the series of operations exemplified in FIGS. 17A, 17B, and 17C, the spring constant of the magnetic spring decreases as vibrating movable body 30 deviates from vibration center position VC. In a case where the spring constant of the magnetic spring decreases as the amplitude increases, the composite spring constant also decreases, and in a case where the composite spring constant decreases, the resonance frequency of movable body 30 also decreases.

In addition, in a case where the driving frequency of upper drive coil 211 and lower drive coil 212 decreases, the resonance frequency decreases, and in a case where the driving frequency of upper drive coil 211 and lower drive coil 212 increases, the resonance frequency increases. Therefore, since the resonance frequency changes in the same direction as a direction in which the driving frequency changes, the frequency bandwidth in which the output of the desired vibration intensity is possible is widened. This point is as described in detail in the description of Embodiment 1.

### Embodiment 8

Hereinafter, Embodiment 8 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

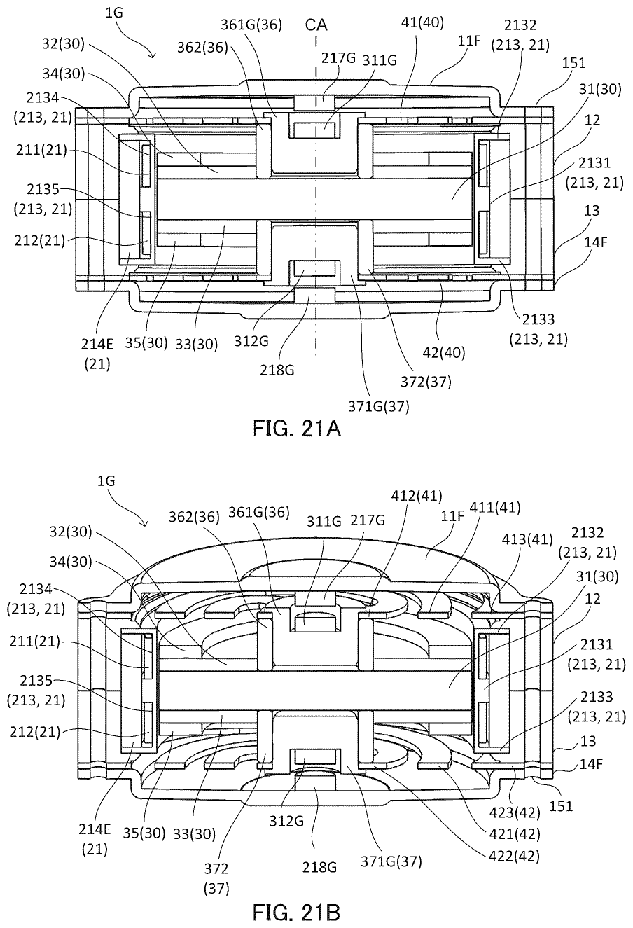

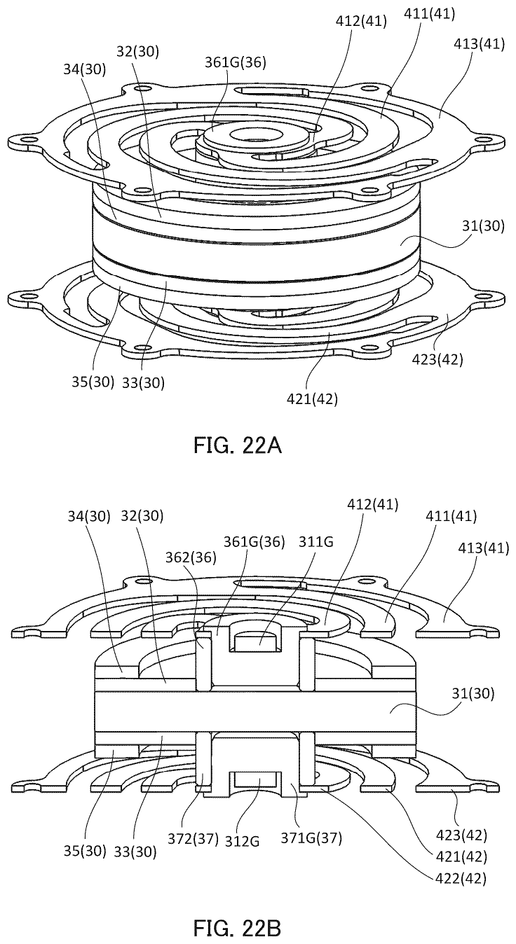

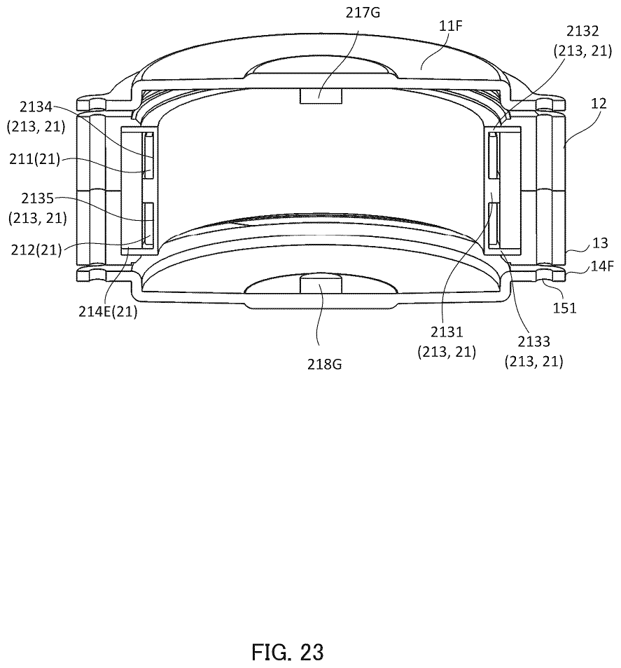

FIG. 21A is a side sectional view of a vibration actuator according to the present embodiment, and FIG. 21B is a perspective sectional view of the vibration actuator according to the present embodiment. FIG. 22A is a perspective view of a movable body on which a leaf spring is mounted in the vibration actuator according to the present embodiment, and FIG. 22B is a perspective sectional view of the movable body shown in FIG. 22A. FIG. 23 is a perspective sectional view of a fixed body of the vibration actuator according to the present embodiment.

In vibration actuator 1G according to the present embodiment, fixed body 20 includes fixed magnets 217G and 218G that are held by upper lid portion 11F and lower lid portion 14F, respectively, to face, in the up-down direction, movable body 30, specifically additional movable magnets 311G and 312G disposed at connection portions 36 and 37 that connect movable body 30 respectively to upper leaf spring 41 and lower leaf spring 42. Fixed magnets 217G and 218G are examples of the magnetic member provided in fixed body 20 to constitute a magnetic spring, together with additional movable magnets 311G and 312G, that generates a magnetic force for biasing vibrating movable body 30 toward vibration center position VC.

Fixed magnets 217G and 218G are permanent magnets magnetized in the up-down direction in advance. Fixed magnets 217G and 218G are magnetized such that polarities of end portions facing additional movable magnets 311G and 312G are opposite to polarities of facing surfaces of additional movable magnets 311G and 312G. As a result, a magnetic attractive force is always generated between fixed magnets 217G and 218G and movable body 30 (additional movable magnets 311G and 312G).

Fixed magnets 217G and 218G are disposed on surfaces of upper lid portion 11F and lower lid portion 14F that face movable body 30. In the present embodiment, each of fixed magnets 217G and 218G has a relatively low-profile shape such as a flat plate shape. Fixed magnets 217G and 218G are disposed to face additional movable magnets 311G and 312G in the up-down direction from both the upward and downward directions at a central portion in the radial direction.

In the present embodiment, additional movable magnets 311G and 312G facing fixed magnets 217G and 218G are disposed in recessed portions provided in distal end portions (flange-side end portions) of insertion pins 361G and 371G of connection portions 36 and 37. Additional movable magnets 311G and 312G are permanent magnets magnetized in advance in the up-down direction. Since the recessed portions for accommodating additional movable magnets 311G and 312G are provided in insertion pins 361G and 371G, it is possible to suppress an increase in size of entire vibration actuator 1.

The present embodiment is the same as Embodiments 6 and 7 in that an effect of varying the spring constant of the magnetic spring is not exhibited between fixed yoke 214E and movable magnet 31. As described above, in the present embodiment, the effect is exhibited by fixed magnets 217G and 218G. Since the principle by which this effect is exhibited is the same as the principle described with reference to FIGS. 17A, 17B, and 17C in Embodiment 6, the detailed description thereof will be omitted here.

In the series of operations exemplified in FIGS. 17A, 17B, and 17C, the spring constant of the magnetic spring decreases as vibrating movable body 30 deviates from vibration center position VC. In a case where the spring constant of the magnetic spring decreases as the amplitude increases, the composite spring constant also decreases, and in a case where the composite spring constant decreases, the resonance frequency of movable body 30 also decreases.

In addition, in a case where the driving frequency of upper drive coil 211 and lower drive coil 212 decreases, the resonance frequency decreases, and in a case where the driving frequency of upper drive coil 211 and lower drive coil 212 increases, the resonance frequency increases. Therefore, since the resonance frequency changes in the same direction as a direction in which the driving frequency changes, the frequency bandwidth in which the output of the desired vibration intensity is possible is widened. This point is as described in detail in the description of Embodiment 1.

### Embodiment 9

Hereinafter, Embodiment 9 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

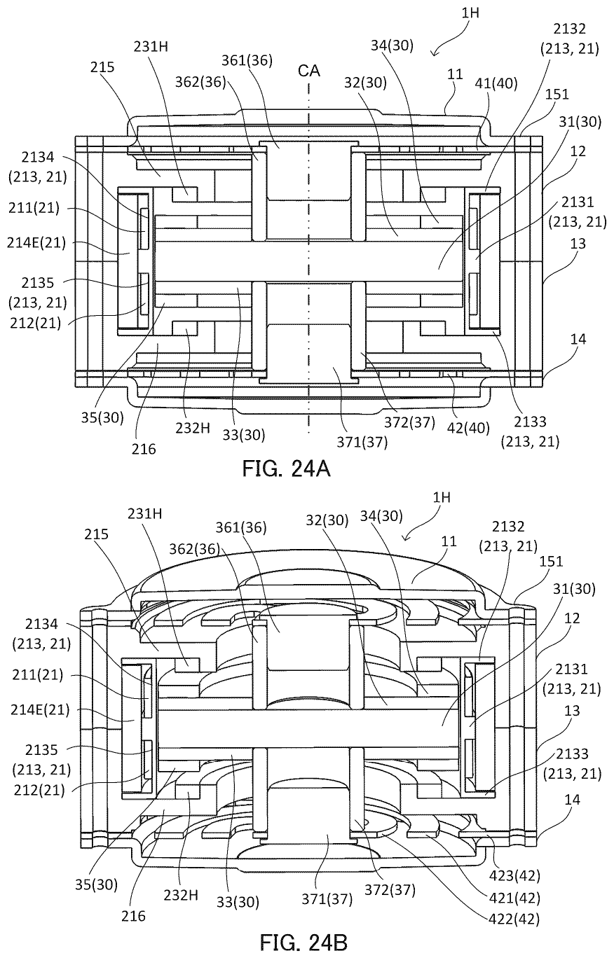

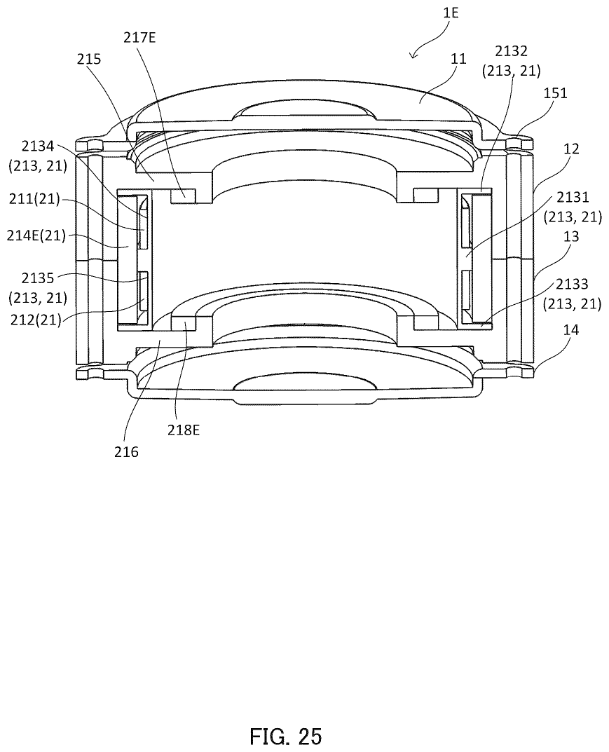

FIG. 24A is a side sectional view of a vibration actuator according to the present embodiment, and FIG. 24B is a perspective sectional view of the vibration actuator according to the present embodiment. FIG. 25 is a perspective sectional view of a fixed body of the vibration actuator according to the present embodiment.

Vibration actuator 1H according to the present embodiment is different from Embodiment 6 in that fixed magnetic materials 231H and 232H, which are non-magnetized magnetic materials, are disposed instead of fixed magnets 217E and 218E provided as the magnetic member in fixed body 20 in Embodiment 6. The present embodiment is the same as Embodiment 6 in the other respects. In addition, fixed magnetic materials 231H and 232H are different from fixed magnets 217E and 218E in that fixed magnetic materials 231H and 232H are not magnetized, but the shapes, the placement positions, and the like of fixed magnetic materials 231H and 232H are the same as those of fixed magnets 217E and 218E. That is, fixed magnetic materials 231H and 232H are, in the present embodiment, examples of the magnetic member provided in fixed body 20 to constitute a magnetic spring, together with movable magnet 31, that generates a magnetic force for biasing vibrating movable body 30 toward vibration center position VC.

Therefore, in the present embodiment, since the same effect as that of Embodiment 6 can be achieved without increasing the number of permanent magnets used, there is an advantage in terms of the manufacturing cost.

### Embodiment 10

Hereinafter, Embodiment 10 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described.

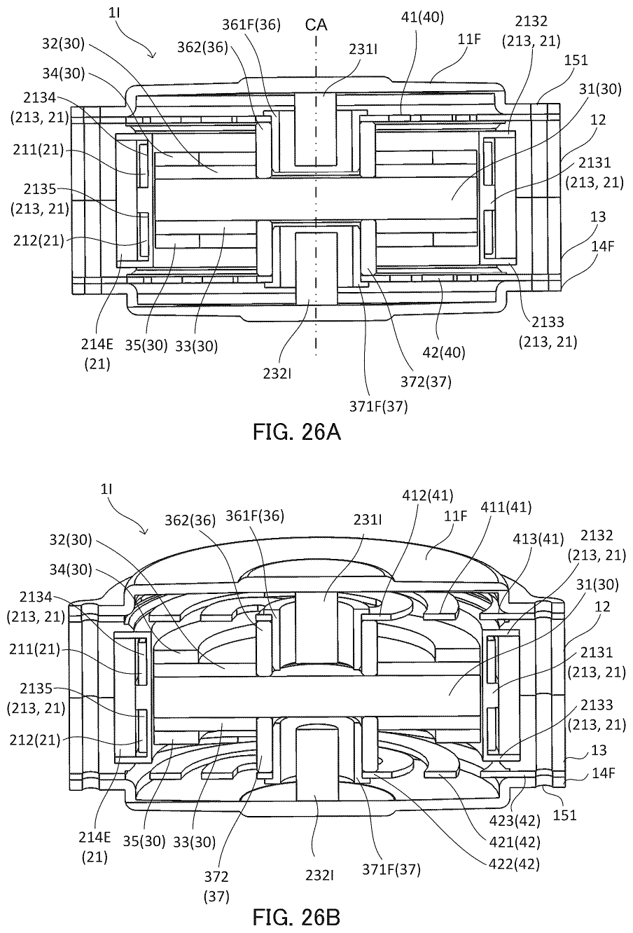

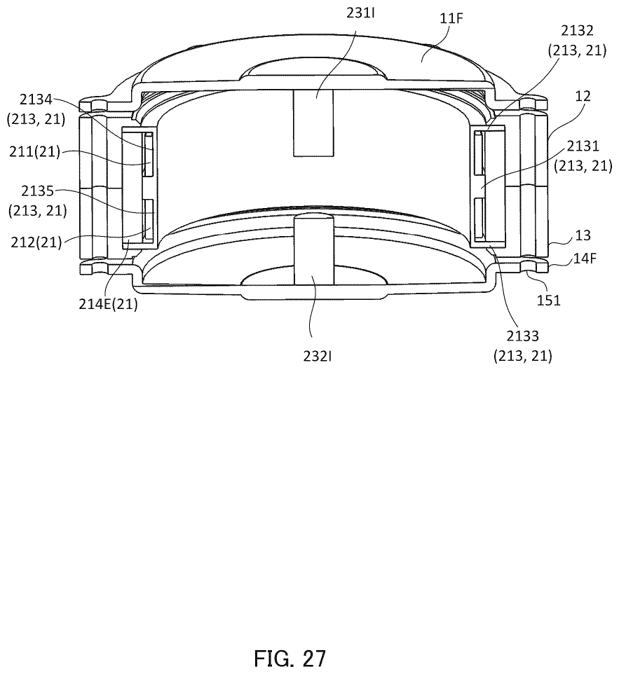

FIG. 26A is a side sectional view of a vibration actuator according to the present embodiment, and FIG. 26B is a perspective sectional view of the vibration actuator according to the present embodiment. FIG. 27 is a perspective sectional view of a fixed body of the vibration actuator according to the present embodiment.

Vibration actuator 11 according to the present embodiment is different from Embodiment 7 in that fixed magnetic materials 231I and 232I, which are non-magnetized magnetic materials, are disposed instead of fixed magnets 217F and 218F provided as the magnetic member in fixed body 20 in Embodiment 7. The present embodiment is the same as Embodiment 7 in the other respects. In addition, fixed magnetic materials 231I and 232I are different from fixed magnets 217F and 218F in that fixed magnetic materials 231I and 232I are not magnetized, but the shapes, the disposition positions, and the like of fixed magnetic materials 231I and 232I are the same as those of fixed magnets 217F and 218F. That is, fixed magnetic materials 231I and 232I are, in the present embodiment, examples of the magnetic member provided in fixed body 20 to constitute a magnetic spring, together with movable magnet 31, that generates a magnetic force for biasing vibrating movable body 30 toward vibration center position VC.

Therefore, in the present embodiment, since the same effect as that of Embodiment 7 can be achieved without increasing the number of permanent magnets used, there is an advantage in terms of the manufacturing cost.

### Embodiment 11

Hereinafter, Embodiment 11 of the present invention will be described. In the present embodiment, the same reference numerals are assigned to the portions common to or corresponding to those in the above-described embodiment, and detailed description thereof will be omitted or simplified. Here, a difference from the above-described embodiment will be mainly described. Since a configuration of the present embodiment is relatively similar to the configuration of Embodiment 7 among the above-described embodiments, a difference from Embodiment 7 will be mainly described.

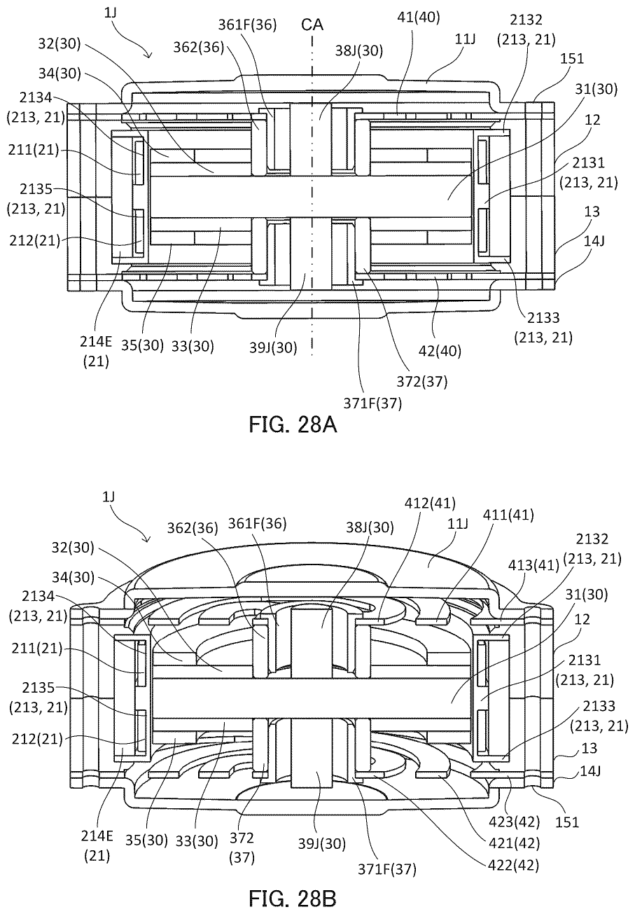

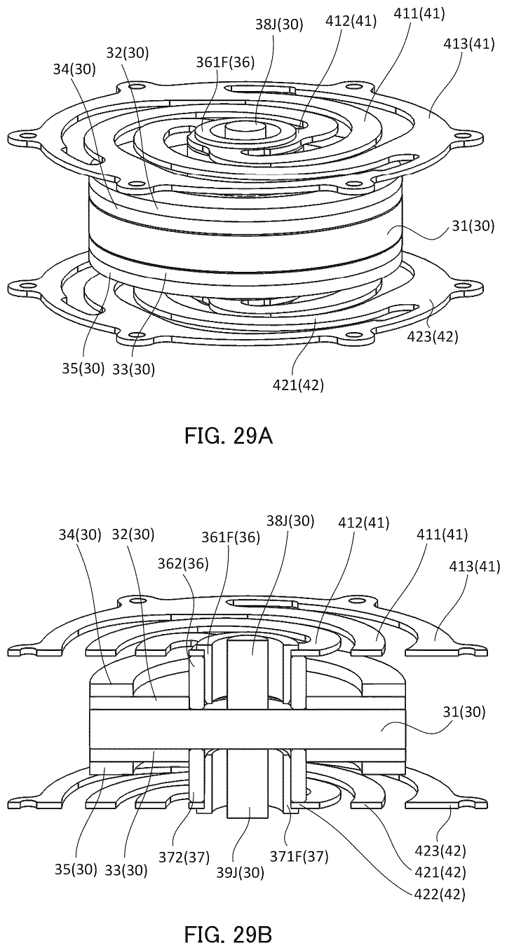

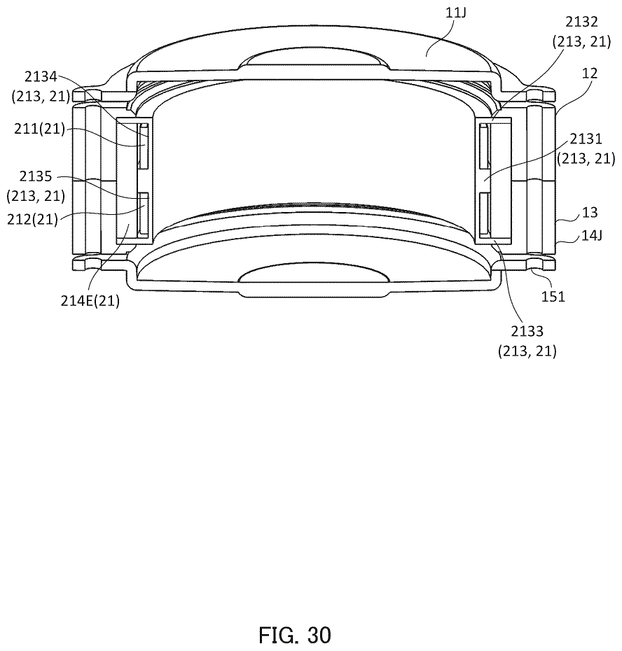

FIG. 28A is a side sectional view of a vibration actuator according to the present embodiment, and FIG. 28B is a perspective sectional view of the vibration actuator according to the present embodiment. FIG. 29A is a perspective view of a movable body on which a leaf spring is mounted in the vibration actuator according to the present embodiment, and FIG. 29B is a perspective sectional view of the movable body shown in FIG. 29A. FIG. 30 is a perspective sectional view of a fixed body of the vibration actuator according to the present embodiment.

Vibration actuator 1J according to the present embodiment is different from Embodiment 7 in that upper lid portion 11J and lower lid portion 14J, both of which are formed of non-magnetized magnetic materials, are disposed instead of upper lid portion 11F and lower lid portion 14F in Embodiment 7. Upper lid portion 11J and lower lid portion 14J are different from upper lid portion 11 and lower lid portion 14 described in Embodiment 1 and the like only in that upper lid portion 11J and lower lid portion 14J are formed of a non-magnetized magnetic material, and are the same in the other points.

Movable magnet 31 of movable body 30 includes movable magnetic materials 38J and 39J, both of which are formed of a non-magnetized magnetic material, at central portions in the radial direction on the upper surface and the lower surface. Movable magnetic materials 38J and 39J are accommodated in hollow portions of inner tubular portions 361F and 371F of connection portions 36 and 37 that respectively connect movable body 30 to upper leaf spring 41 and lower leaf spring 42, and extend in a rod shape in both the upward and downward directions from the upper surface and the lower surface of movable magnet 31 to face upper lid portion 11J and lower lid portion 14J. Instead of providing movable magnetic materials 38J and 39J on movable magnet 31 of movable body 30, outer tubular portions 362 and 372 provided to be in contact with the upper surface and the lower surface of movable magnet 31 and inner tubular portions 361F and 371F provided inside outer tubular portions 362 and 372 may be used as magnetic members, respectively.

With this configuration, a magnetic attractive force is always generated between upper lid portion 11J and lower lid portion 14J and movable body 30 (movable magnet 31). That is, upper lid portion 11J and lower lid portion 14J are, in the present embodiment, examples of the magnetic member provided in fixed body 20 to constitute a magnetic spring, together with movable magnet 31, that generates a magnetic force for biasing vibrating movable body 30 toward vibration center position VC.

The present embodiment is the same as Embodiment 6 in that an effect of varying the spring constant of the magnetic spring is not exhibited between fixed yoke 214E and movable magnet 31. As described above, in the present embodiment, the effect is exhibited by upper lid portion 11J and lower lid portion 14J. Since the principle by which this effect is exhibited is the same as the principle described with reference to FIGS. 17A, 17B, and 17C in Embodiment 6, the detailed description thereof will be omitted here.

In the series of operations exemplified in FIGS. 17A, 17B, and 17C, the spring constant of the magnetic spring decreases as vibrating movable body 30 deviates from vibration center position VC. In a case where the spring constant of the magnetic spring decreases as the amplitude increases, the composite spring constant also decreases, and in a case where the composite spring constant decreases, the resonance frequency of movable body 30 also decreases.

In addition, in a case where the driving frequency of upper drive coil 211 and lower drive coil 212 decreases, the resonance frequency decreases, and in a case where the driving frequency of upper drive coil 211 and lower drive coil 212 increases, the resonance frequency increases. Therefore, since the resonance frequency changes in the same direction as a direction in which the driving frequency changes, the frequency bandwidth in which the output of the desired vibration intensity is possible is widened. This point is as described in detail in the description of Embodiment 1.

The embodiments of the present invention have been specifically described above, but the present invention is not limited to the specific embodiments described above. Various variations and modifications can be made to the specific examples described in the above embodiments within the scope of the gist of the present invention described in the claims.

The disclosure of Japanese Patent Application No. 2023-023768, filed on Feb. 17, 2023, including the specification, drawings and abstract, is incorporated herein by reference in its entirety.

### INDUSTRIAL APPLICABILITY

The vibration actuator according to the aspect of the present invention can widen a frequency bandwidth in which a desired vibration intensity can be output, and is useful for being mounted in electric devices including electronic devices such as a game machine terminal and a mobile terminal, various massage devices and beauty devices, and the like.

### REFERENCE SIGNS LIST

1, 1A, 1B, 1C, 1D, 1E, 1F, 1G, 1H, 1I, 1J, 5204, 5205, 5206 Vibration actuator
10 Case
11, 11F, 11J Upper lid portion
12 Upper circumferential wall portion (circumferential wall portion)
13 Lower circumferential wall portion (circumferential wall portion)
14, 14F, 14J Lower lid portion
15 Coupling portion
151 Fastening hole
20 Fixed body
21 Drive coil assembly
211 Upper drive coil
212 Lower drive coil
213 Bobbin
2131 Intermediate flange
2132, 2133 End portion flange
2134, 2135 Groove
214, 214A, 214B, 214C, 214D, 214E Fixed yoke
214B1 Inner stepped portion
214C1 Outer stepped portion
214D1 Inclined inner circumferential surface
215, 216 Magnetic member holding portion
217E, 217F, 217G, 218E, 218F, 218G Fixed magnet
231H, 231I, 232H, 232I Fixed magnetic material
30 Movable body
31 Movable magnet
311G, 312G Additional movable magnet
32, 33 Main movable yoke
34, 35 Sub-movable yoke
36, 37 Connection portion
361, 361G, 371, 371G Insertion pin
361F, 371F Inner tubular portion
362, 372 Outer tubular portion
38J, 39J Additional movable magnetic material
40 Leaf spring part
41 Upper leaf spring
411 Arm portion
412 Inner circumferential portion
413 Outer circumferential portion
42 Lower leaf spring
421 Arm portion
422 Inner circumferential portion
423 Outer circumferential portion
5201 Communication section
5202 Processing section
5203 Drive control section
CA Central axis
C1, C2 Frequency characteristic curve
GC Game controller
La1 Length of movable-body main body in up-down direction
Lb1 Length of fixed yoke in up-down direction
Lm1 Length of movable range in up-down direction
M Mobile terminal
P Intermediate portion
VC Vibration center position (center position)
W1, W2 Frequency bandwidth

1. A vibration actuator, comprising:
a movable body that includes a movable magnet;
a fixed body that includes a pair of coils disposed side by side in an axial direction such that each of the pair of coils surrounds an outer circumference of the movable body, the pair of coils constituting, together with the movable magnet, a motor that causes the movable body to vibrate in the axial direction when the pair of coils are energized; and
a magnetic spring that includes the movable magnet and a magnetic member provided in the fixed body, and generates a magnetic force for biasing the vibrating movable body toward a center position of the vibration, wherein
the magnetic spring is configured such that a magnetic force generated in a case where a displacement of the movable body from the center position is large is smaller than a magnetic force generated in a case where the displacement of the movable body from the center position is small.

2. The vibration actuator according to claim 1, wherein
the magnetic member includes a fixed yoke disposed on an outer side in a radial direction with respect to the pair of coils, and the fixed yoke has a preset shape and dimension such that the magnetic force generated in the case where the displacement of the movable body from the center position is large is smaller than the magnetic force generated in the case where the displacement of the movable body from the center position is small.

3. The vibration actuator according to claim 2, wherein:
the fixed yoke extends in both directions of the axial direction from an intermediate portion corresponding to the center position, and
in the axial direction, a length of the fixed yoke is shorter than a length of a movable range of the movable body.

4. The vibration actuator according to claim 3, wherein:
the fixed yoke extends in the both directions of the axial direction from the intermediate portion corresponding to the center position, and
in the axial direction, the length of the fixed yoke is equal to a length of the movable body.

5. The vibration actuator according to claim 2, wherein:
the fixed yoke extends in both directions of the axial direction from an intermediate portion corresponding to the center position, and
an inner diameter of both end portions of the fixed yoke in the axial direction is larger than an inner diameter of the intermediate portion.

6. The vibration actuator according to claim 5, wherein
the fixed yoke includes an inner stepped portion in which an inner diameter is changed between the intermediate portion and each of the both end portions.

7. The vibration actuator according to claim 6, wherein
an outer surface of the fixed yoke is flat over an entire length in the axial direction.

8. The vibration actuator according to claim 5, wherein
the fixed yoke includes an outer stepped portion in which an outer diameter is changed between the intermediate portion and each of the both end portions.

9. The vibration actuator according to claim 5, wherein
the fixed yoke includes an inclined portion in which an inner diameter gradually increases from the intermediate portion to the both end portions.

10. The vibration actuator according to claim 1, wherein
the magnetic member includes a pair of fixed magnets that are disposed to face the movable body respectively from both sides in the axial direction, each of which generates an attractive force to the movable magnet.

11. The vibration actuator according to claim 10, wherein
the pair of fixed magnets extend annularly to face the outer circumference of the movable magnet.

12. The vibration actuator according to claim 10, wherein
the pair of fixed magnets extend in a rod shape to approach the movable magnet from the both sides in the axial direction at a central position in a radial direction.

13. The vibration actuator according to claim 10, wherein:
the movable magnet includes a first movable magnet and a pair of second movable magnets that are disposed at a central position in a radial direction on both sides of the first movable magnet in the axial direction and have a smaller diameter than the first movable magnet, and
the pair of fixed magnets are disposed respectively to face the pair of second movable magnets from the both sides in the axial direction at the central position in the radial direction.

14. The vibration actuator according to claim 1, wherein
the magnetic member includes a pair of fixed magnetic materials that are disposed to face the movable body respectively from both sides in the axial direction, each of which generates an attractive force to the movable magnet.

15. The vibration actuator according to claim 14, wherein
the pair of fixed magnetic materials extend annularly to face the outer circumference of the movable magnet.

16. The vibration actuator according to claim 14, wherein
the pair of fixed magnetic materials extend in a rod shape to approach the movable magnet from the both sides in the axial direction at a central position in a radial direction.

17. The vibration actuator according to claim 14, wherein:
the movable body further includes a pair of movable magnetic materials that are disposed to extend in a rod shape from the movable magnet in both directions of the axial direction at a central position in a radial direction, and
the pair of fixed magnetic materials are disposed respectively to face the pair of movable magnetic materials from the both sides in the axial direction at the central position in the radial direction.

18. An electric device that is handheld or wearable, the electric device comprising:
the vibration actuator according to claim 1.
